(19) United States
(12) Patent Application Publication
(10) Pub. No.: US 2026/0085666 A1
(43) Pub. Date: Mar. 26, 2026

(54) POWER GENERATION SYSTEM USING A THERMOCHEMICAL ENERGY STORAGE SYSTEM OR A THERMAL ENERGY STORAGE SYSTEM

(71) Applicant: RedoxBlox, Inc., San Diego, CA (US)

(72) Inventors: Alessandro Bo, San Diego, CA (US); James F. Klausner, San Diego, CA (US); Joerg Petrasch, Dornbirn (AT)

(21) Appl. No.: 19/341,428

(22) Filed: Sep. 26, 2025

Related U.S. Application Data
(60) Provisional application No. 63/699,267, filed on Sep. 26, 2024.

(51) Int. Cl. F03G 7/00

(52) U.S. Cl. CPC F03G 7/00

(57) ABSTRACT

In accordance with the purpose(s) of the present disclosure, as embodied and broadly described herein, the disclosure, in one aspect, relates to a power generation system integrated with an energy storage device. In some aspects, the energy storage device can be a thermochemical energy storage device, a thermal energy storage device, or other suitable energy storage device. In one aspect, the power generation system is comprised of a thermal energy storage (TES) device or a thermochemical energy storage (TCES) device that is configured to increase a thermal energy storage capacity or a thermochemical energy storage capacity by passing an electrical current directly through the energy storage material. The power generation system can further comprise a controller that is configured to operate the power generation system in a charging mode, a discharging mode, a charging while discharging mode, or in other suitable modes.

### CROSS-REFERENCE TO RELATED APPLICATIONS

This application claims the benefit of and priority to U.S. Provisional Application No. 63/699,267, filed Sep. 26, 2024, entitled “Power Generation System Using a Thermochemical Energy Storage System,” the entire contents of which is hereby incorporated herein by reference.

### BACKGROUND

Renewable energy sources are used with traditional power generation systems in order to improve energy efficiency. Power generation from renewable energy sources can be inherently variable. As such, renewable energy sources can be used in combination with an energy storage system to compensate for fluctuations in renewable power generation. The energy storage system can store excess energy when energy production exceeds demand and release the stored energy when an electrical grid has an energy demand that exceeds production.

### SUMMARY

In accordance with the purpose(s) of the present disclosure, as embodied and broadly described herein, the disclosure, in one aspect, relates to a power generation system integrated with an energy storage device. In some aspects, the energy storage device can be a thermochemical energy storage (TCES) device, a thermal energy storage (TES) device, or other suitable energy storage device. In one aspect, the power generation system is comprised of a thermal energy storage (TES) device or a thermochemical energy storage (TCES) device that is configured to increase a thermal energy storage capacity or a thermochemical energy storage capacity by passing an electrical current directly through the energy storage material. The power generation system can further comprise a controller that is configured to operate the power generation system in a charging mode, a discharging mode, a charging while discharging mode, or in other suitable modes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a power generation system according to one example of the present disclosure.

FIG. 2 is a drawing depicting another example of the power generation system according to one example of the present disclosure.

FIG. 3 is a drawing depicting another example of the power generation system with a recuperator according to one example of the present disclosure.

FIG. 4 is a drawing depicting another example of the first power generation system with a recuperator according to one example of the present disclosure.

FIG. 5 is a drawing depicting another example of the power generation system with a steam generator according to one example of the present disclosure.

FIG. 6 is a drawing depicting another example of the first power generation system according to one example of the present disclosure.

FIG. 7 is a drawing depicting an example of an oxygen extraction system for the power generation system according to one example of the present disclosure.

FIG. 8 is a drawing depicting another example of an oxygen extraction system for the power generation system according to one example of the present disclosure.

FIG. 9 is a drawing depicting another example of an oxygen extraction system for the power generation system according to one example of the present disclosure.

FIG. 10 is a drawing depicting another example of an oxygen extraction system for the power generation system according to one example of the present disclosure.

FIG. 11 is a drawing depicting another example of an oxygen extraction system for the power generation system according to one example of the present disclosure.

FIG. 12 is a drawing depicting another example of an oxygen extraction system for the power generation system according to one example of the present disclosure.

FIG. 13 is a drawing depicting an example of the power generation system with a steam generator according to one example of the present disclosure.

FIG. 14 is a drawing depicting another example of the power generation system with a steam generator according to one example of the present disclosure.

FIG. 15 is a drawing depicting a second power generation system with an expander system according to one example of the present disclosure.

FIG. 16 is a drawing depicting another example of the second power generation system with a mixing air compressor according to one example of the present disclosure.

FIG. 17 is a drawing depicting a third power generation system with a fuel injection system according to one example of the present disclosure.

FIG. 18 is a drawing depicting a power generation system with a combined cycle and a fuel injection system in the steam generator system according to one example of the present disclosure.

FIG. 19 is a drawing depicting a power generation system with a combined cycle and a fuel injection system in both the topping cycle and in the steam generator system according to one example of the present disclosure.

FIGS. 20A and 20B are flowcharts illustrating example methods for the operations of a power generation system.

FIG. 21 is a drawing depicting an example of a power generation system with a heat exchanger for open cycle gas turbines according to one example of the present disclosure.

FIG. 22 is a drawing depicting another example of a power generation system with a heat exchanger for open cycle gas turbines according to one example of the present disclosure.

FIG. 23 is a drawing depicting an example of a power generation system with a heat exchanger for closed cycle gas turbines according to one example of the present disclosure.

FIG. 24 is a drawing depicting a power generation system using a reduction reactor according to one example of the present disclosure.

FIG. 25 is a drawing depicting another example of a power generation system using an oxidation reactor according to one example of the present disclosure.

FIG. 26 is a drawing depicting another example of the power generation system using an oxidation reactor coupled with a steam generator according to one example of the present disclosure.

FIGS. 27 and 28 are flowcharts illustrating another example methods for the operations of a power generation system using a reduction reactor and/or an oxidation reactor according to one example of the present disclosure.

### DETAILED DESCRIPTION

Disclosed are various approaches for integrating a thermal energy storage system or a thermochemical energy storage system into a power generation system. A power generation system can represent a system, e.g. a power plant, that is used to generate electricity for an electrical power grid. Power generation systems can be integrated with energy sources that produce electricity.

For example, renewable energy sources can be integrated into the power generation system. However, renewable energy sources, such as solar photovoltaics, wind turbines, etc., can have power generation that is inherently variable based on environmental conditions. Energy storage in combination with renewable energy sources can be used to accommodate daily and seasonal imbalances in energy consumption and production. However, renewable energy sources cannot sufficiently store excess energy when energy production exceeds demand. Accordingly, there is a need for power generation systems to store excess energy in an energy storage device and for the energy storage device to release the stored energy when an electrical grid has an energy demand that exceeds production.

Accordingly, the various embodiments of the present disclosure are directed to various approaches for integrating a thermal energy storage device (TES) or a thermochemical energy storage (TCES) device into a power generation system. A thermochemical energy storage device can be a system that conducts an oxidation-reduction reaction at elevated temperatures in order to generate heated gas.

In some examples, the TCES device can include a vessel, an energy storage material, a heater, and other suitable components. The heater can be an external heater or integrated within the TCES device. The vessel defines an interior volume containing the energy storage material. The vessel has flow inlet and flow outlet ports to allow for the flow of gas (e.g., air). TCES device can increase the thermochemical energy storage capacity by passing an electrical current directly through the energy storage material. In some examples, the energy storage material can include a reactive material. The reactive material is configured to release oxygen upon being heated to a reduction temperature range, and generate heat when exposed to air or any oxygen-carrying gas and reacting with oxygen. The heater is configured to heat the reactive material. The energy storage material can perform the function of the heater.

The power generation system includes a TCES device (or TES device), an oxygen extraction system, a compressor, a turbine, an electrical generator, a heat engine and/or other suitable components. The oxygen extraction system is configured to remove oxygen from the interior volume of the TCES device when the reactive material is heated. The compressor is configured to provide a gas or a gas mixture, such as air, any oxygen-containing gas, or nitrogen, to the interior volume of the TCES device. In some example configurations, the compressor can provide different gases for different modes of operation for the power generation system. For example, during a charging mode, the compressor can provide nitrogen gas to the interior volume in order to improve the performance of the charging operation by facilitating a better reduction reaction. Subsequently, during a discharge mode, the compressor can provide an oxygen-containing gas. The turbine is configured to receive a heated, oxygen-depleted gas from the interior volume of the TCES device. The electrical generator is configured to be powered by the turbine to generate electricity. Accordingly, the integration of the TCES device and other components enables the power generation system a method of storing energy and releasing energy.

A thermal energy storage (TES) device can be a system that stores sensible thermal energy. In some examples, the TES device can include a vessel, an energy storage material, a heater, and other suitable components, and other suitable components. The heater can be an external heater or integrated within the TES device. The vessel defines an interior volume containing the energy storage material. The vessel has flow inlet and flow outlet ports to allow for the flow of gas (e.g., air). The TES device can increase the thermal energy storage capacity by passing an electrical current directly through the energy storage material. In some example configurations, the energy storage material can perform the function of the heater.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

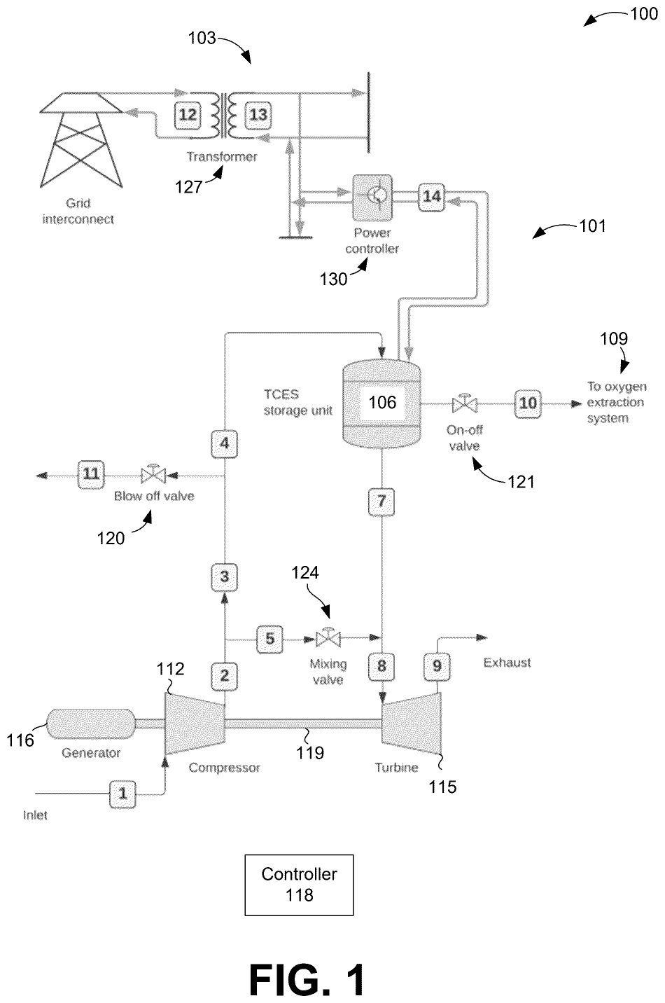

With reference to FIG. 1, shown is a network environment 100 according to various embodiments. The network environment 100 can include a power generation system 101 (referred herein “the system 101”), an electrical grid infrastructure 103, and other suitable components, which can be in data communication with each other via a network. The network can include wide area networks (WANs), local area networks (LANs), personal area networks (PANs), or a combination thereof. These networks can include wired or wireless components or a combination thereof.

The system 101 includes a thermochemical energy storage (TCES) device 106, an oxygen extraction system 109, a compressor 112, a turbine 115, an electrical generator 116, a controller 118, and other suitable components. The system 101 also includes lines 1-5 and 7-11 (e.g., pipes, connectors, inlets, openings, exits), a shaft 119, a blow off valve 120, an on-off oxygen valve 121, a mixing valve 124, and other suitable components.

The electrical grid infrastructure 103 can include a power transformer 127, a power controller 130, and other suitable components. The electrical grid infrastructure 103 can represent one or more electrical components for providing electricity to the system 101 and/or receiving electricity from the system 101. The electrical grid infrastructure 103 can include electrical components for electricity distribution for residential and commercial buildings in an area. In some non-limiting examples, the electrical grid infrastructure 103 or portions of the electrical grid infrastructure 103 can be included into the system 101.

The power transformer 127 is configured to adjust a line voltage to a voltage value needed by the TCES device 106. The power transformer 127 can represent one or more electrical devices designed to transfer electrical power from one circuit to another circuit for alternating current (AC).

The power controller 130 is configured to input a controlled amount of electricity into the TCES device 106, which can heat a reactive material via Joule heating according to a prescribed power rating. In some examples, the power controller 130 is an alternating current-direct current (AC-DC) controlled multi-pulse rectifier relying on either thyristors (also known as silicon controlled rectifiers, SCRs) or insulated-gate bipolar transistors (IGBTs) as semiconductor switches. In another embodiment, the power controller 130 is an AC-AC controlled thyristor system operating, for example, in either phase angle mode, full wave burst mode, or half-wave mode. In another embodiment, the power controller 130 is an on-load tap changer (OLTC) that, via either mechanical or semiconductor switches, automatically selects the appropriate secondary winding of the power transformer 127 depending on the voltage requirements of the TCES device 106. In some of these examples, the power controller 130 can be on the premises or in a regional area of the power generation system 101. In other examples, the power controller 130 is representative of web-based application (e.g., cloud-based service) that regulates the amount electricity provided to the TCES device 106 or received from the TCES device 106 over the network.

The TCES device 106 is used to store thermal (e.g., sensible) energy and chemical energy in an energy storage material contained within a vessel or container. The stored energy within the energy storage material can be released by flowing gas (e.g., air or an oxygen-containing gas) through the energy storage material. The output of the TCES device 106 can be in the form of heated oxygen-depleted gas. The TCES device 106 can be powered by an input of electricity from the power generation system 101 (e.g., excess electricity from the electrical grid infrastructure 103 or other sources), sensible energy, and chemical energy. At a desired time, the TCES device 106 can release the stored energy by flowing gas (e.g., air or an oxygen-containing gas) through the energy storage material. The output of heated oxygen-depleted gas can be used to generate electricity. Accordingly, the TCES device 106 can be operated in an energy charging mode, an energy discharging mode, an energy charging while discharging mode, and other suitable modes. In the context of the present disclosure, oxygen depleted gas can represent no oxygen or an oxygen concentration that is below a threshold or within a threshold range (e.g., between 20% and 25% by volume, or between 15% and 25% by volume, or between 10% and 25% by volume, or between 5% and 25% by volume, or between 0% and 25% by volume). In some examples, a TES device is used instead of a TCES device. When a TES device is implemented, the discharged gas can be just air.

The TCES device 106 is a system that conducts an oxidation-reduction reaction at elevated temperatures in order to generate heated gas. In some examples, the TCES device 106 can include a vessel, an energy storage material, and a heater. The vessel defines an interior volume containing the energy storage material. The vessel has flow inlet and flow outlet ports to allow for the flow of gas (e.g., air). The energy storage material can include a reactive material. The reactive material is configured to release oxygen upon being heated to a reduction temperature range, and generate heat when exposed to air or any oxygen-carrying gas and reacting with oxygen. The heater is configured to heat the reactive material. The energy storage material can perform the function of the heater.

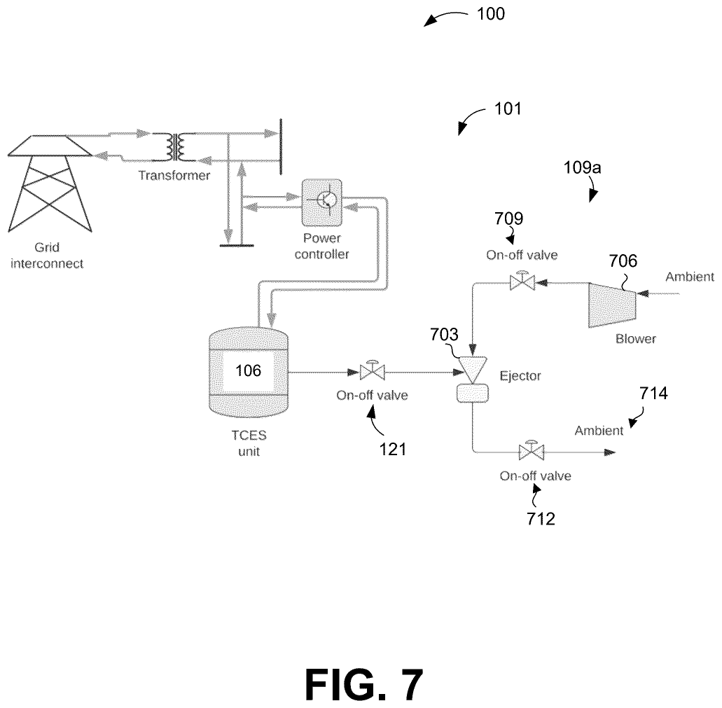

The oxygen extraction system 109 is configured to remove oxygen from an interior volume of the TCES device 106 when the reactive material is heated. For example, the oxygen extraction system 109 can be configured to remove oxygen generated by a thermochemical reduction reaction from an interior portion of the TCES device 106. Various examples of the oxygen extraction system 109 have been described in the present disclosure (see e.g., at least FIGS. 7-19). As will be described, the oxygen extraction system 109 can generate a suction force to extract the generated oxygen from the interior volume of the TCES device 106 (e.g., during a charging mode of the operation). Oxygen must be removed to avoid an overpressure within the vessel (for which the vessel may not be rated for). Also, the oxygen must be provided a safe path to the environment. For example, the oxygen must be prevented from existing through the compressor and/or the turbine as the oxygen would melt the compressor, the turbine, and/or related components. Additionally, with a TES device implementation, the oxygen extraction system 109 can be omitted or turned off.

The oxygen extraction system 109 described in the present disclosure can provide advantages over a simple blower arrangement. The blower concept, while still valid, requires the pressure vessel (e.g., of the TCES device 106) to be designed for both “positive” and “negative” pressure operation. While this is desirable for system efficiency (better energy density), this inevitably adds to system cost. As such, the oxygen extraction systems 109 that will be described can enable less components and/or lower cost to build the TCES device 106.

In some examples, instead of the TCES device 106, a TES device can be used in the system 101 and other systems that will be subsequently described. As such, in the context of the present disclosure, the TCES device 106 shown in FIG. 1 and subsequent figures can represent a TES device as well. When a TES device is used instead of a TCES device, the system 101 may omit certain components, such as an oxygen extraction system 109 and other suitable components.

The compressor 112 is configured to provide compressed air to the TCES device 106. The compressor 112 is configured to receive gas (e.g., air) from an inlet line 1, compress the gas, and provide the compressed gas to the TCES device 106. In some examples, the compressor 112 is configured to provide the compressed air during a discharging mode of operation.

The turbine 115 is a mechanical device that is used to actuate the electrical generator 116 for generating electricity. The turbine 115 includes mechanical components (e.g., blades) that rotate a shaft 119 of the electrical generator for generating electricity. In the illustrated example of FIG. 1, the turbine 115 and the compressor 112 are attached to a shaft 119. Other examples in the present disclosure include arrangements in which a common shaft 119 is not attached between the turbine 115 and the compressor 112. In some examples, the turbine 115 is the expander of a gas turbine, and other suitable gas expansion devices. As such, a gas turbine can include the turbine 115, the compressor, the shaft 119, and other suitable components. In some embodiments, the power generation system 101 can include one or more of a gas turbine, a heat engine, and/or other suitable systems. In the embodiments of the present disclosure, the turbine 115 can omit a traditional combustor section because the TCES device 106 can provide the turbine 115 heated gas for actuation.

The electrical generator 116 is a device that is configured to be powered by the actuation of the turbine 115 in order to generate electricity. The turbine 115 can rotate the shaft 119 for the electrical generator 116 for generating electricity. The electrical generator 116 can supply the generated electricity to the electrical grid infrastructure 103 and/or other suitable loads. In another example, the generator 116 is replaced with a mechanical load (e.g., a natural gas compressor for example). This enables other operating modes (e.g. charge-while-discharge).

The controller 118 can be a computing device that controls the operation of the system 101. The controller 118 can be in data communication in order to control valves, components, switches and other suitable components of the system 101. From these components, the controller 118 can receive status information and provide instructions for component operations. The controller 118 can include a processor, a memory, and/or a network interface. For example, the controller 118 can be configured to perform computations on behalf of other computing devices or applications. The controller 118 can execute software, an application, or a set of machine-readable instructions.

Moreover, the controller 118 can employ a plurality of computing devices that can be arranged in one or more server banks or computer banks or other arrangements. Such computing devices can be located in a single installation or can be distributed among many different geographical locations. For example, the controller 118 can represent a plurality of computing devices that together can include a hosted computing resource, a grid computing resource or any other distributed computing arrangement. In some cases, the controller 118 can correspond to an elastic computing resource where the allotted capacity of processing, network, storage, or other computing-related resources can vary over time.

The various embodiments can include a number of different arrangements of the components for the system 101. In some embodiments, an inlet line 1 (e.g., piping, tubing, opening, etc.) can be in fluid (e.g., gas) connection with a compressor 112. The compressor 112 can be in fluid connection with the TCES device 106 via lines 2, 3, and 4. The compressor 112 can be in fluid connection with a blow off valve 120. The blow off valve 120 can be configured to maintain pressurization or depressurization requirements for one or more lines and the turbine 115. For example, the blow off valve 120 can facilitate (e.g., based on instructions from the controller 118) depressurizing a line, the TCES device 106, and the turbine 115 within a certain amount of time. A mixing valve 124 is on line 5 which is in fluid connection between lines 2 and 8. The compressor 112 can have a mechanical connection with the turbine 115 via the shaft 119.

The TCES device 106 can be in fluid connection with the turbine 115 and an on-off oxygen valve 121 (also referenced as “the oxygen valve 121”). The on-off oxygen valve 121 can be in fluid connection with the oxygen extraction system 109. The TCES device 106 can be electrically coupled to the power controller 130, which is electrically coupled to the power transformer 127.

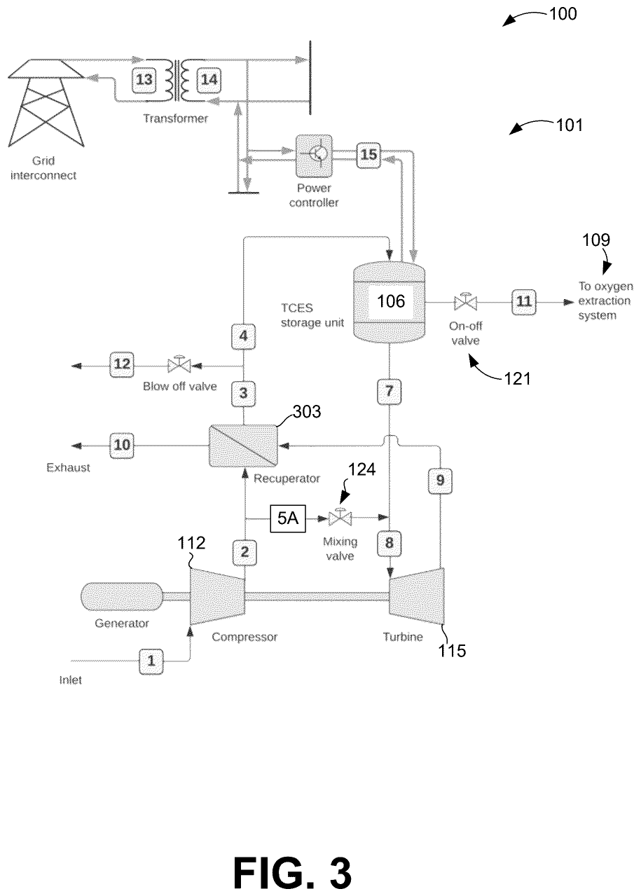

In some embodiments, a recuperator (see e.g., FIG. 3) can also be present. In some embodiments, a bottoming cycle (combined cycle configuration) including a heat recovery steam generator (HRSG) and a steam turbine, for example, can also be present. In one embodiment, the electrical grid infrastructure 103 includes, for example, a power transformer 127 connected to a power controller 130. The power transformer 127 adjusts the line voltage to the required value by the TCES device 106. The power controller 130 can be configured to input a controlled amount of electricity into the TCES device 106, ultimately heating the reactive material via Joule heating according to a prescribed power rating. In one embodiment, the power controller 130 is an AC-DC controlled multi-pulse rectifier relying on either thyristors (also known as silicon controlled rectifiers, SCRs) or insulated-gate bipolar transistors (IGBTs) as semiconductor switches. In another embodiment, the power controller 130 is an AC-AC controlled thyristor system operating, for example, in either phase angle mode, full wave burst mode, or half-wave mode. In another embodiment, the power controller 130 is an on-load tap changer (OLTC) that, via either mechanical or semiconductor switches, automatically selects the appropriate secondary winding of the power transformer 127 depending on the voltage requirements of the TCES device 106. The oxygen extraction system 109 is configured to remove oxygen from the interior volume of the TCES device 106 when the reactive material is heated.

In one embodiment, the TCES device 106 is coupled with a simple cycle gas turbine plant, which is an example of the power generation system 101 as shown in FIG. 1. Upon a discharge of the TCES device 106, the on/off oxygen valve 121 is closed and the oxygen extraction system 109 is inactive. The high-temperature gas exiting the TCES device 106 is mixed with the compressor discharge air (e.g., from line 5) to keep the gas temperature at or below the nominal turbine inlet temperature, which can range between 85° and 1500° C., for example. In some examples, nominal compressor discharge air pressures can be between 3 and 45 bar absolute. Compressor discharge air temperatures can be between 15° and 700° C., for example. The mixing valve 124 is a control valve that can bypass a variable amount of gas depending on the gas temperature exiting the TCES device 106. Control on the mixing valve 124 can be performed, for example, by measuring the turbine exhaust gas temperature with a temperature sensor on line 9. In another example, a pyrometer can be used to measure either the temperature in the TCES device 106, the temperature in line 7, the temperature in line 8, and other suitable locations. In another example, the temperature of the TCES device 106 can be inferred from measuring the temperature-dependent electrical resistance of the energy storage material. Under nominal operating conditions, no air bypass takes place (e.g., when the mixing valve 124 is fully closed) when the outlet temperature of the TCES device 106 is below the nominal turbine inlet temperature. The mixing valve 124 can be, for example, a butterfly valve, a ball valve, a segmented ball valve, a globe valve, a diaphragm valve, a globe valve, an angle valve, a gate valve, a needle valve, a plug valve, a pinch valve, among others. The mixing valve 124, the oxygen valve 121, other valves, pressure sensors, temperature sensors, and other suitable devices can be in data communication with and by the controller 118.

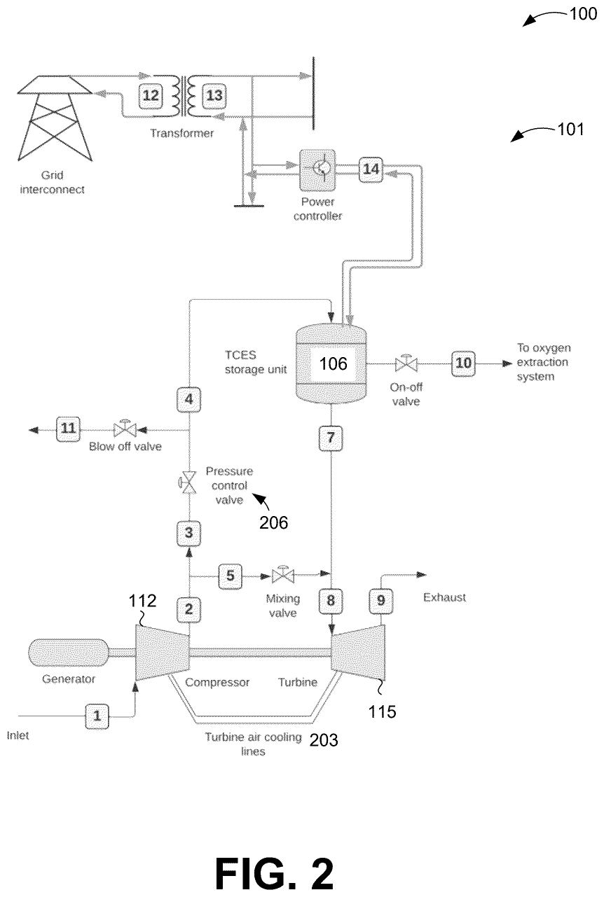

With reference to FIG. 2, shown is the network environment 100 with another example of the power generation system 101. In this example, the system 101 includes turbine air cooling lines 203, a pressure control valve 206, and other suitable components. The system 101 includes turbine air cooling lines 203 between the compressor 112 and the turbine 115. The turbine air cooling lines 203 connect the different compressor stages of the compressor 112 to the different turbine stages of the turbine 115 and are used when the turbine inlet temperature (e.g., at line 8) exceeds the operating temperature of the turbine blades materials. Turbine air cooling is usually needed when the turbine inlet temperature exceeds 950° C., for example. In one example, the air-cooling mass flow rate is a function of the pressure difference between the point of air extraction (on the compressor side) and the point of air injection (on the turbine side). In a traditional gas turbine engine, this pressure difference is primarily determined by the aerodynamic characteristics of the combustor section. As the TCES device 106 replaces the combustor section, the gas path connecting lines 2 and 8 can provide a similar pressure drop characteristics to the combustor section it replaces to have similar turbine blade air-cooling performances. As the TCES device 106 can have significantly lower pressure drops relative to a traditional combustor section (0.1%, relative to the compressor discharge pressure, versus 2% to 4% for a traditional gas turbine combustor, for example), an additional pressure control valve 206 is installed at the inlet of the TCES device 106 at line 3. The pressure control valve 206 acts to match the pressure drop that would result between the gas path through the TCES device 106 (e.g., from line 2 to line 8) and the original gas path with the combustor section in place.

In some examples, a pressure gauge (e.g., a differential pressure gauge) for monitoring the pressure in one or more lines (e.g., across lines 3 and 7) can provide pressure measurements to the controller 118. Based on the pressure measurements, the pressure control valve 206 can be adjusted to maintain or set a pressure reading in one or more lines associated with the TCES device 106 and the turbine 115. The pressure control valve 206 can be, for example, a butterfly valve, a ball valve, a segmented ball valve, a globe valve, a diaphragm valve, a globe valve, an angle valve, a gate valve, a needle valve, a plug valve, a pinch valve, a pulsating on-off valve, among others. In another embodiment, the pressure control valve 206 can be replaced by a passive element (e.g., an orifice) that introduces a fixed pressure drop across the line between line 2 and line 8.

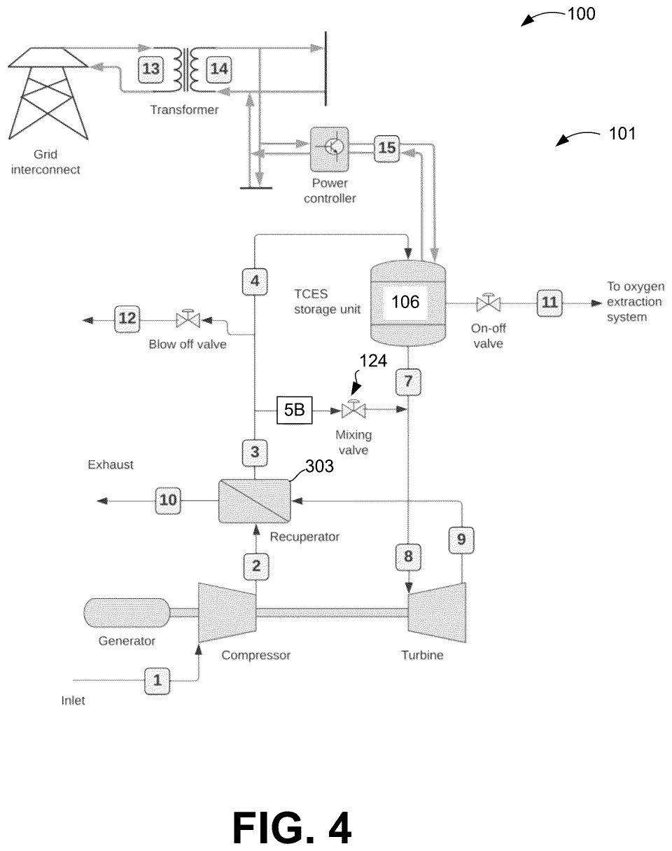

Moving to FIG. 3 and FIG. 4, shown are other examples of the power generation system 101 in the network environment 100. In the illustrated examples of FIG. 3 and FIG. 4, the power generation system 101 includes a recuperator 303 that is in fluid connection with the turbine 115 via line 9. The recuperator 303 is a type of heat exchanger that has separate flow paths for each fluid throughout its passages and heat is transferred through the separation walls. The recuperator 303 can be positioned within an exhaust path in order to recover heat and apply the heat to another area. The recuperator 303 is in fluid connection with line 2, line 3, line 9, and line 10. The line 9 is connected to an exhaust outlet on the turbine 115 and transports the exhaust to the recuperator 303.

FIG. 3 and FIG. 4 differ in the location of line 5 (5A & 5B) for the mixing valve 124. In FIG. 3, the mixing valve 124 is on line 5A, which provides a fluid connection between lines 2 and 8. In this arrangement, the mixing valve 124 can provide compressed air from the compressor 112 to the line 8 in order to mix with the heated oxygen depleted gas from the TCES device 106.

In FIG. 4, the mixing is on line 5B, which provides a fluid connection between lines 3 and 7. In this arrangement, the mixing valve 124 can provide compressed air from the recuperator to the line 7 in order to mix with the heated oxygen depleted gas from the TCES device 106.

In another embodiment, the TCES device 106 is coupled with a recuperated cycle gas turbine plant. Upon TCES device discharge, the on/off oxygen valve 121 is closed and the oxygen extraction system 109 is inactive. The high-temperature gas exiting the TCES device 106 is mixed with either the compressor discharge air (e.g., see FIG. 3) or the recuperator discharge air (e.g., see FIG. 4) to keep the gas temperature at or below the nominal turbine inlet temperature. Nominal mixing air pressures can be between 3 and 45 bar absolute, for example. Bypass air temperatures can be between 20° and 650° C., for example. The mixing valve 124 is a control valve that can bypass a variable amount of gas depending on the gas temperature exiting the TCES device 106. Control on the mixing valve 124 can be performed, for example, by measuring the turbine exhaust gas temperature at line 9 via a temperature sensor. As previously mentioned, a pyrometer can be used measure either the temperature in the TCES device 106, the temperature in line 7, the temperature in line 8, and other suitable locations. The temperature of the TCES device 106 can also be measured indirectly by measuring the electrical resistance of the energy storage material and correlating its electrical resistivity to its temperature.

Under nominal operating conditions, no air bypass takes place (e.g., mixing valve 124 fully closed) when the TCES device 106 outlet temperature (e.g., a temperature sensor inside the TCES device 106, on line 7, on line 8, or on line 9t) is below the nominal turbine inlet temperature. The turbine inlet temperature can be back-calculated from the temperature measured at the exhaust if the turbine expansion ratio and its expansion efficiency are also known. The mixing valve 124 can be, for example, a butterfly valve, a ball valve, a segmented ball valve, a globe valve, a diaphragm valve, a globe valve, an angle valve, a gate valve, a needle valve, a plug valve, a pinch valve, a pulsating on-off valve, among others. An additional pressure control valve can be installed at the inlet of the TCES device 106, similarly to what shown in FIG. 2.

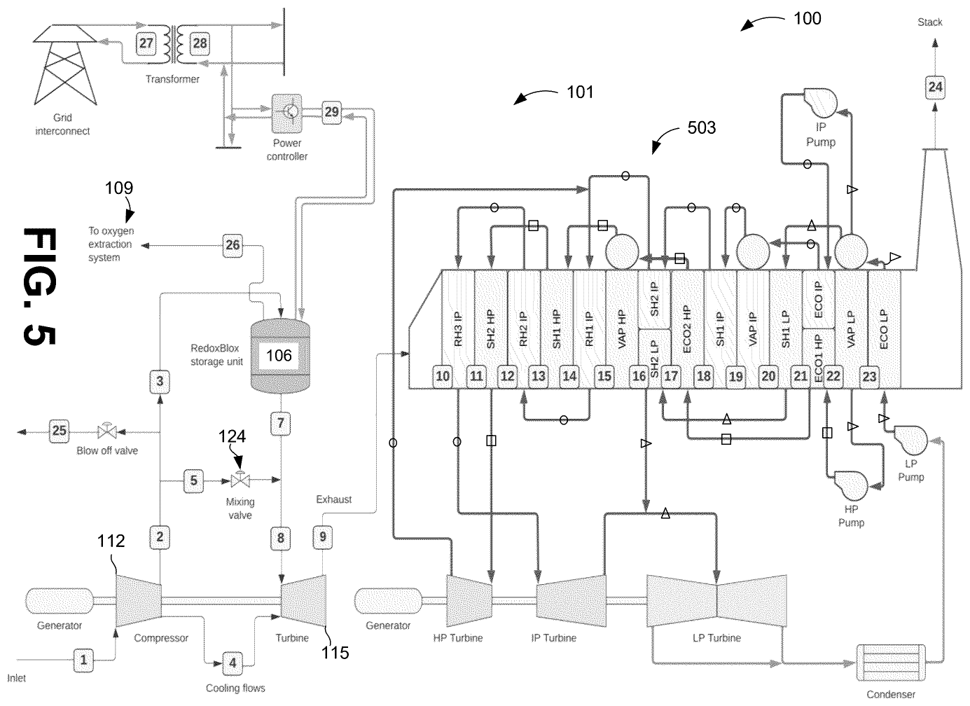

With reference to FIG. 5, shown is another example of the power generation system 101 in the network environment 100. In the illustrated example of FIG. 5, the power generation system 101 includes a steam generation system 503. The illustrated example in FIG. 5 of the power generation system 101 can represent a combined cycle power plant. In FIG. 5, the power generation system 101 has the turbine 115 in fluid connection with the steam generator system 503 by way of line 9. Line 9 provides the exhaust from the turbine 115 to the steam generator system 503. In the illustrated example of FIG. 5, the power generation system 101 can represent a system that uses a combination of a gas turbine and a steam turbine to produce more electricity with higher efficiency in comparison to a traditional simple cycle plant system.

As shown in FIG. 5, the TCES device 106 is coupled with the steam generator system 503, in which LP steam lines have a triangle, IP steam lines for a circle, and HP steam lines have a square in the figure for illustration purposes. Upon the discharge of the TCES device 106, an on/off oxygen valve (not shown) can be positioned on line 26 between the oxygen extraction system 109 and the TCES device 106. When the on/off oxygen valve is closed, the oxygen extraction system 109 is inactive. The high-temperature gas exiting the TCES device 106 is mixed with the compressor discharge air (e.g., via mixing valve 124 and line 5) to keep the gas temperature at or below the nominal turbine inlet temperature. Mixing air pressures can be in a range between 3 and 45 bar absolute, for example. Bypass air temperatures can be between 20° and 650° C., for example. The mixing valve 124 is a control valve that can bypass a variable amount of gas depending on the gas temperature exiting the TCES device 106. Control on the mixing valve 124 can be performed, for example, by measuring the turbine exhaust gas temperature. As previously mentioned, a pyrometer can be used to measure either the temperature in the TCES device 106, the temperature in line 7, the temperature in line 8, and other suitable locations.

Under normal operating conditions, no air bypass takes place (e.g., mixing valve 124 fully closed) when the TCES device outlet temperature is below the nominal turbine inlet temperature. The mixing valve 124 can be, for example, a butterfly valve, a ball valve, a segmented ball valve, a globe valve, a diaphragm valve, a globe valve, an angle valve, a gate valve, a needle valve, a plug valve, a pinch valve, pulsating on-off valve, among others. An additional pressure control valve can be installed at the inlet of the TCES device 106, similarly to what shown in FIG. 2. The turbine exhaust air (e.g., see line 9 in FIG. 5) is then introduced into the steam generator system 503 to generate steam at one or more pressure levels, which is then expanded into a steam turbine to generate electrical power. In some examples, the steam generator system 503 is a heat recovery steam generator (HRSG). FIG. 5 depicts a potential configuration with a sub-critical, three-pressure level combined cycle power plant. In such a plant, steam is generated at a low pressure (LP), intermediate pressure (IP), and high-pressure (HP). In other embodiments, the combined cycle power plant can rely on a supercritical heat recovery steam generator or ultra-super critical heat recovery steam generator.

This implementation provides advantages over prior designs. With sulfur bearing fuels, the stack temperature at 24 is usually limited above the condensation point of hydrogen sulfide (e.g. 140° C.), which would otherwise combine with water vapor and form sulfuric acid (H₂SO₄), which would corrode the heat exchanging surfaces. The optimal stack temperature at 24 can now be further reduced to increase the plant efficiency as no sulfur is present in the system.

The other advantage is the minimum operating load (usually limited by excess of CO and/or NOₓ emissions) can be further reduced, adding to the plant operational flexibility (i.e., it can change its load in a wider range relative to an equivalent fossil fuel fired system). Also, the HRSG is now simpler as no emission control systems (e.g., selective catalytic reduction systems, ammonia injection grids) are strictly necessary.

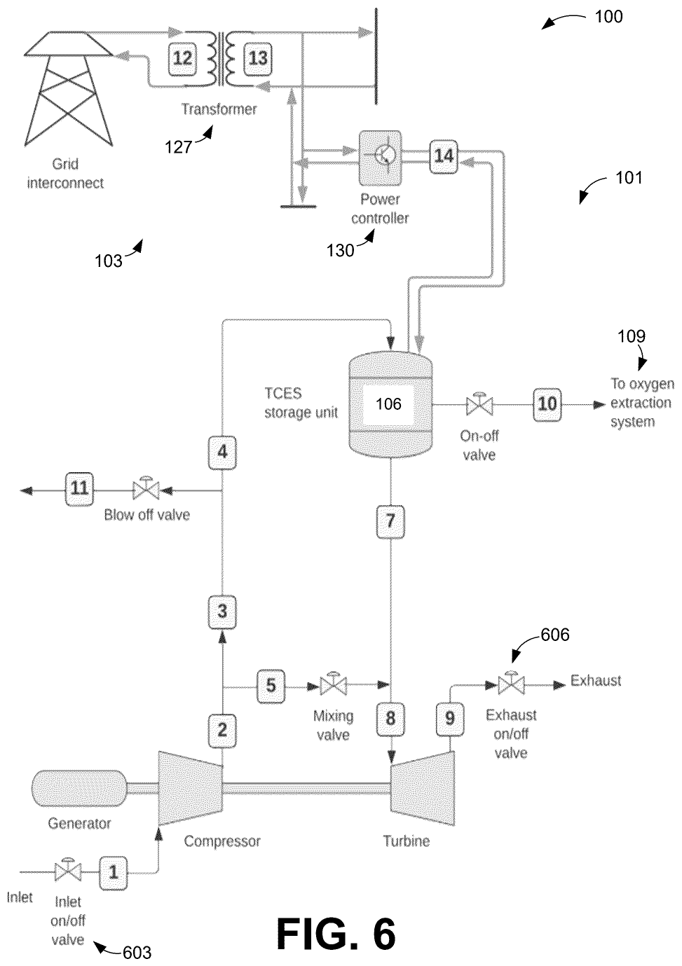

FIG. 6 illustrates another example of the power generation system 101 in the network environment 100. In FIG. 6, the power generation system 101 includes an on/off inlet valve 603 on line 1 and an on/off exhaust valve 606 on line 9. To charge the TCES device 106, the power controller 130 is activated and controls the electrical power flow into TCES device 106. As the temperature within the TCES device 106 increases, it releases high-temperature oxygen gas. The oxygen extraction system 109 manages the extraction of this oxygen gas stream towards the environment. Different embodiments of the oxygen extraction system 109 are presented below.

In one embodiment, the oxygen extraction system 109 includes an industrial blower (not shown) that extracts high-temperature gas while reducing the internal pressure of the TCES device 106 between 0.01 and 0.1 bar absolute, for example. One example embodiment of such a configuration is shown in FIG. 6. In FIG. 6, the on/off inlet valve 603 and the on/off exhaust valve 606 are installed at the compressor inlet and at the turbine exhaust, respectively, and are fully closed when the oxygen extraction system 109 is reducing the internal pressure of the TCES device 106. Accordingly, the on/off inlet valve 603 and the on/off exhaust valve 606 can be closed during a charging mode of the TCES device 106. The pressure is reduced by the blower present in 109. The inlet/outlet valves can be used to “seal” the system from the atmosphere. They essentially help the blower achieve the “low pressure” in the system which includes the TCES device 106.

FIG. 7 illustrates a portion of the power generation system 101 with an oxygen extraction system 109a. Various example embodiments can operate the oxygen extraction system 109 at close to atmospheric conditions (e.g., slightly above or slightly below atmospheric pressure, for example). In this illustrated example of FIG. 7, the oxygen extraction system 109a includes an ejector system 703, an atmospheric blower 706, an on/off blower valve 709, on/off ambient valve 712, and other suitable components. The ejector system 703 is in fluid connection with an oxygen valve 121 and receives oxygen extracted from an interior of the TCES device 106 when the oxygen valve 121 is opened. The atmospheric blower 706 provides a flow of ambient air to the ejector system 703. The flow of ambient air generates a suction force for extracting the oxygen from the interior of the TCES device 106.

The ejector system 703 is configured to remove oxygen or air from the TCES device 106 by generating a lower pressure region within the ejector system 703 relative to the pressure within the TCES device 106. The ejector system 703 is driven by an atmospheric blower 706. The suction section of the ejector system 703 is connected to an opening of the TCES device 106 via an on/off oxygen valve 121. During the charging mode, the on/off oxygen valve 121 is opened, and the atmospheric blower's 706 primary flow through the ejector system 703 generates the suction force needed to extract the oxygen out of the TCES device 106 and through ambient exit opening 714. Also, during charging mode, the on/off blower valve 709 and on/off ambient valve 712 are opened. During discharging mode or during storage mode, the on/off blower valve 709 and on/off ambient valve 712 can be closed.

In some examples, the oxygen extraction system 109a includes an on/off blower valve 709 is situated in a fluid connection between the ejector system 703 and the atmospheric blower 706. Further, the oxygen extraction system 109a can include an ambient valve 712 that is situated in a fluid connection between the ejector system 703 and an ambient exit opening 714. The oxygen is extracted and released through the ambient exit opening 714.

In some examples, multiple ejector systems 703 can be used in parallel to increase the oxygen flow rate suction capacity. Multiple ejector systems 703 can be used in series to increase the suction (reduce the absolute pressure) and increase the energy density of the TCES device 106. In this context, the meaning here should be that the pressure at 703 is further reduced. Technically the suction pressure increases as the delta relative to the ambient increases. A combination of multiple ejector systems 703 connected in series and in parallel can be used to achieve higher oxygen flow rate suction capacity. Series-parallel configurations can help in achieving higher suction pressures and higher suction flow rates. For example, series configurations can help achieve higher suction pressures and parallel configurations can help achieve higher suction flow rates. For instance, with respect to FIG. 7, a parallel connection can be implemented by duplicating the entire oxygen extraction system 109a. A second line with the same oxygen extraction 109a system can come from the TCES device 106. In a variant, the second line can be made after the on-off oxygen valve 121. With reference to FIG. 7, in a series connection, the ejector exhaust is connected to the inlet of a second ejector placed downstream. The second ejector has its own blower.

Depending on the gas temperature evolving through the ejector system 703, its materials of construction can be carbon steel, stainless steel, high-temperature austenitic stainless steel, nickel-based superalloys (e.g., Hastelloy X, Inconel 718, Haynes 214), and ceramic materials (e.g., alumina, alumina-silica, zirconia, yttria-stabilized zirconia, silicon carbide), for example.

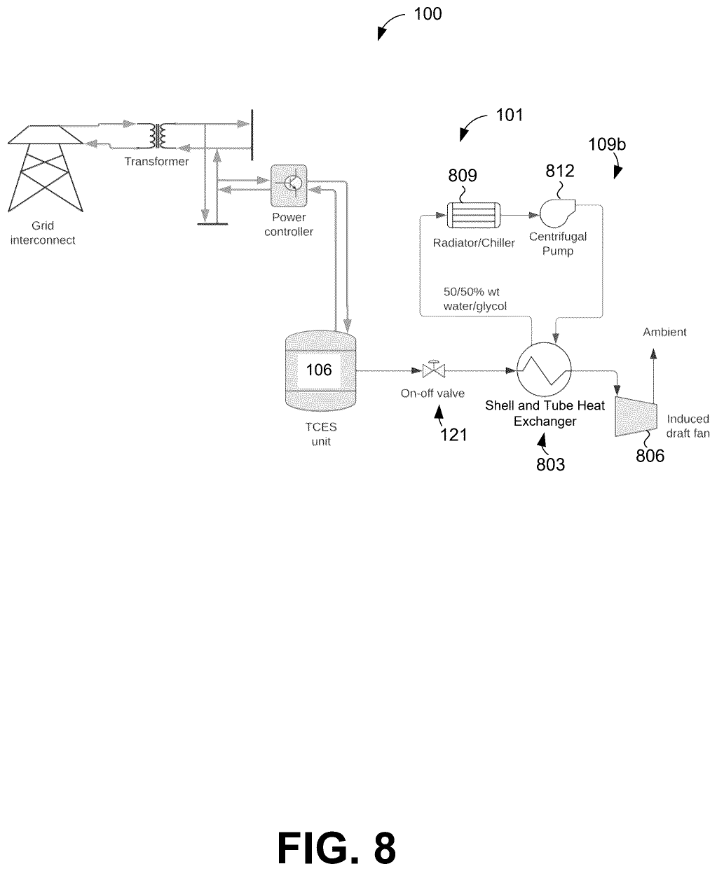

FIG. 8 illustrates a portion of the power generation system 101 with an oxygen extraction system 109b. The oxygen extraction system 109b includes a heat exchanger 803, an atmospheric blower 806, and other suitable components. The heat exchanger 803 can include a radiator/chiller 809, a centrifugal pump 812, and other suitable components. The heat exchanger 803 is configured to reduce the temperature of the extracted oxygen before being ejected out into the atmosphere. The advantages of this implementation have been previously described.

In the example shown in FIG. 8, the oxygen gas stream is extracted via the atmospheric blower 806. In between the atmospheric blower 806 and the on/off oxygen valve 121 on the oxygen extraction port for the TCES device 106, the high-temperature heat exchanger 803 is placed. The high-temperature heat exchanger 803 can be of shell and tube or plate configuration, for example, and can be configured to reduce the oxygen gas temperature to a lower value, between 4° and 800° C., for example, prior entering the high temperature atmospheric blower 806. The heat exchanger 803 can be a gas-to-gas or a gas-to-liquid heat exchanger, for example. In a gas-to-liquid configuration, the liquid cooling system can be in a closed loop configuration. The cooling system could dissipate heat to the environment via a radiator or chiller device 809 and a centrifugal pump 812. In some examples, the heat exchanger 803 can be configured for a 50/50% weight mixture of water and glycol.

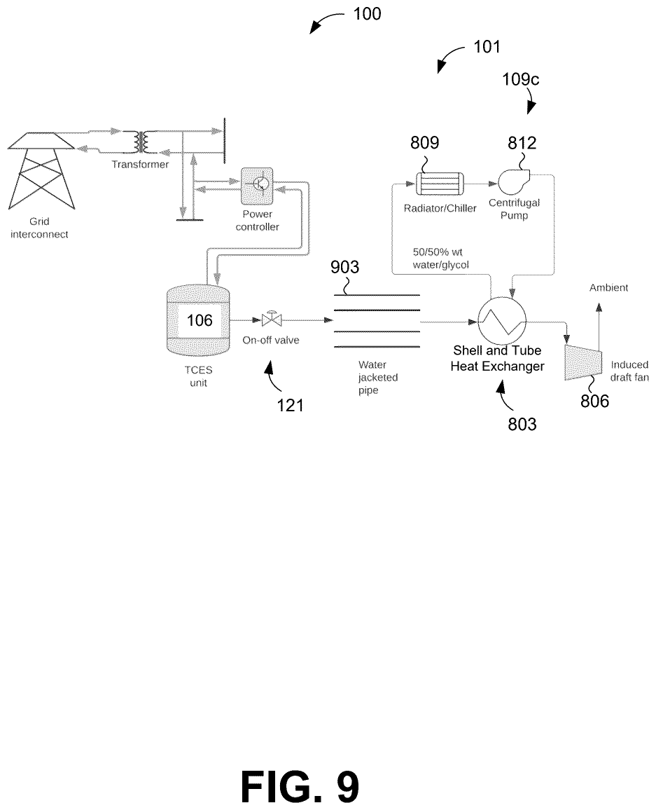

FIG. 9 illustrates a portion of the power generation system 101 with an oxygen extraction system 109c. The oxygen extraction system 109c includes a jacketed pipe 903 between the TCES vessel oxygen extraction port of the TCES device 106 and the heat exchanger 803. The jacketed pipe 903 can be a water filled pipe that carries the extracted gas containing oxygen. The gas carrying section of the jacketed pipe 903 can be in fluid connection from the on/off oxygen valve 121 to the heat exchanger 803.

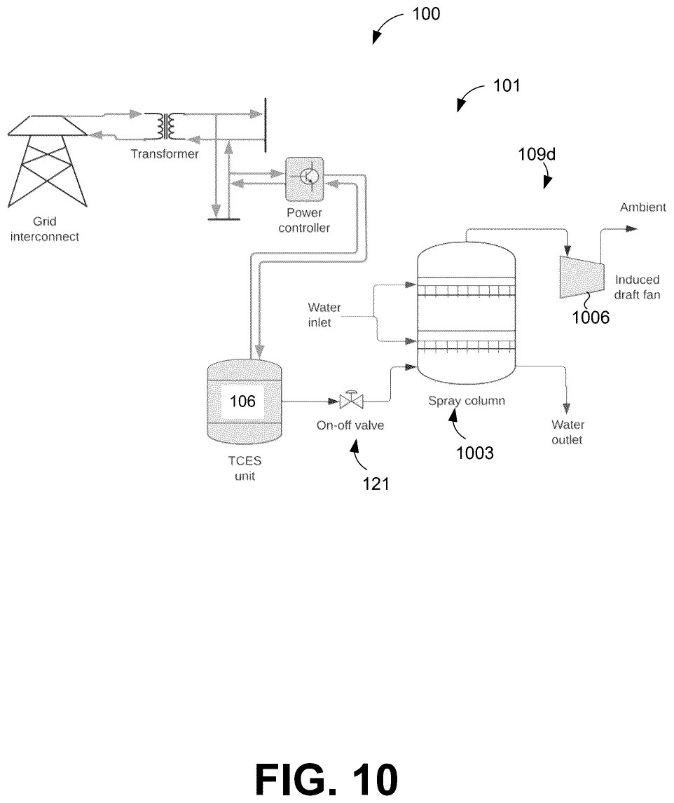

FIG. 10 illustrates a portion of the power generation system 101 with an oxygen extraction system 109d. The oxygen extraction system 109d includes a water spray column 1003 and an atmospheric industrial blower 1006. The water spray column 1003 is in fluid connection with the on/off oxygen valve 121. The water spray column 1003 can also have one or more water inlet ports and a water outlet port. The water spray column 1003 is in fluid connection with the atmospheric industrial blower 1006.

In this example, FIG. 10 shows a water spray column 1003 between the TCES vessel oxygen extraction port of the TCES device 106 and the atmospheric industrial blower 1006. The suction pressure is generated by an atmospheric industrial blower 1006.

The above embodiments (see e.g., FIGS. 6 and 8-10) operate directly on removing a stream of high concentration of oxygen (up to 100%, by volume, for example) from the energy storage module. However, this is not true for the case of the ejector (see FIG. 7) as the oxygen is diluted with ambient air (21% oxygen, by volume) as it enters into 703. Other examples are possible in which the oxygen gas stream is mixed with ambient temperature air to 1) reduce the gas mixture temperature, and 2) reduce the oxygen concentration in the gas stream. This has the benefit of reducing the materials requirements for all the downstream equipment as well as the overall system heat losses.

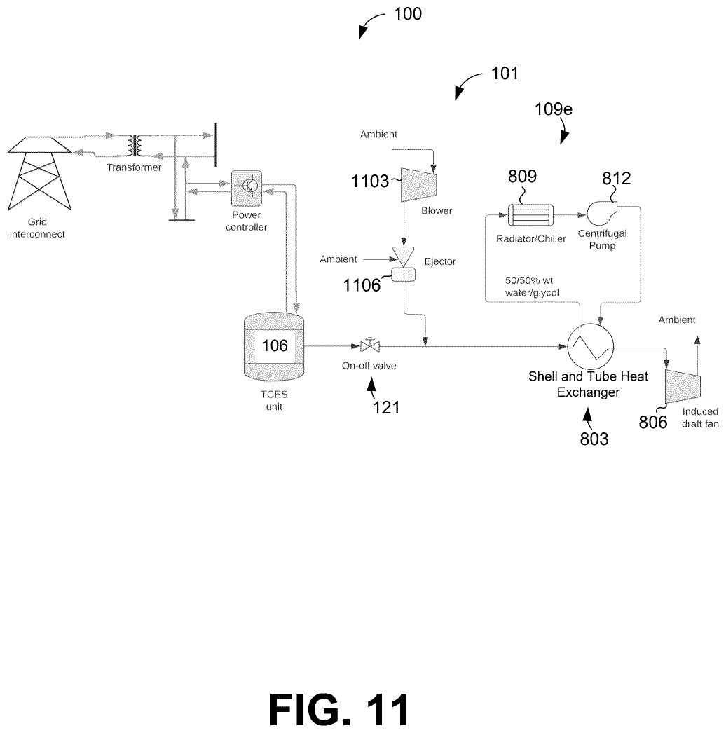

Next, FIG. 11 illustrates a portion of the power generation system 101 with an oxygen extraction system 109e. The oxygen extraction system 109e includes a second blower system 1103, a second ejector system 1106, and other suitable components.

In this illustrated example, the second blower system 1103 and the second ejector system 1106 are placed between the on/off oxygen valve 121 on the oxygen extraction port of the TCES device 106 and the heat exchanger inlet of the heat exchanger 803. The second blower system 1103 and the second ejector system 1106 can provide ambient air and mix the ambient air with the high temperature oxygen. In this non-limiting example, the ambient air is provided in order to reduce the gas mixture temperature at values between 100° and 50° C., for example, and the oxygen concentration to between 40% and 25%, by volume, for example, from the TCES device 106.

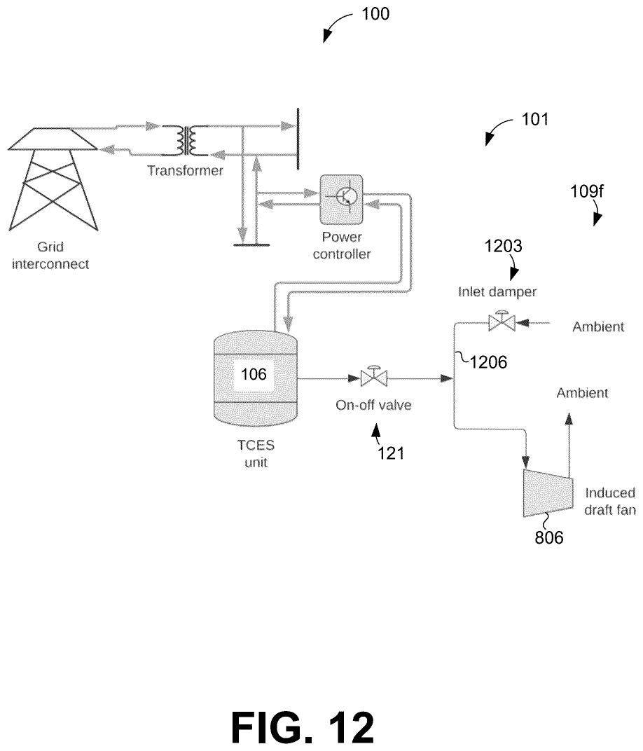

Next, FIG. 12 illustrates a portion of the power generation system 101 with an oxygen extraction system 109f. In this illustrated example, the oxygen extraction system 109f includes an inlet damper 1203. The inlet damper 1203 is configured to adjust an inflow of ambient air. The oxygen gas is extracted using an atmospheric blower 806. The atmospheric blower 806 is also connected to a pipe 1206 connected to the atmosphere. The mixing between the high-temperature oxygen exiting from the TCES device 106 and the ambient temperature air will reduce the overall mixture temperature (to, between 80° and 50° C., or lower, for example), as well as the oxygen concentration (to, between 40% and 25%, by volume, or lower, for example) prior entering the atmospheric blower 806. The amount of mixing is controlled on the pipe 1206 connected to the atmosphere via the inlet damper 1203 by adjusting its opening angle, for example.

In one example, a high-temperature rated sensible thermal or thermochemical energy storage material can be interposed towards the oxygen extraction system outlet section. As oxygen is released, it will be forced to pass through the sensible thermal or thermochemical energy storage material and release heat to it, reducing the oxygen gas temperature being extracted prior entering the oxygen extraction system. This measure can be added to all the embodiments outlined above (e.g., FIG. 6-12) to improve the effectiveness in reducing the oxygen temperature exiting the oxygen extraction port of the TCES device 106.

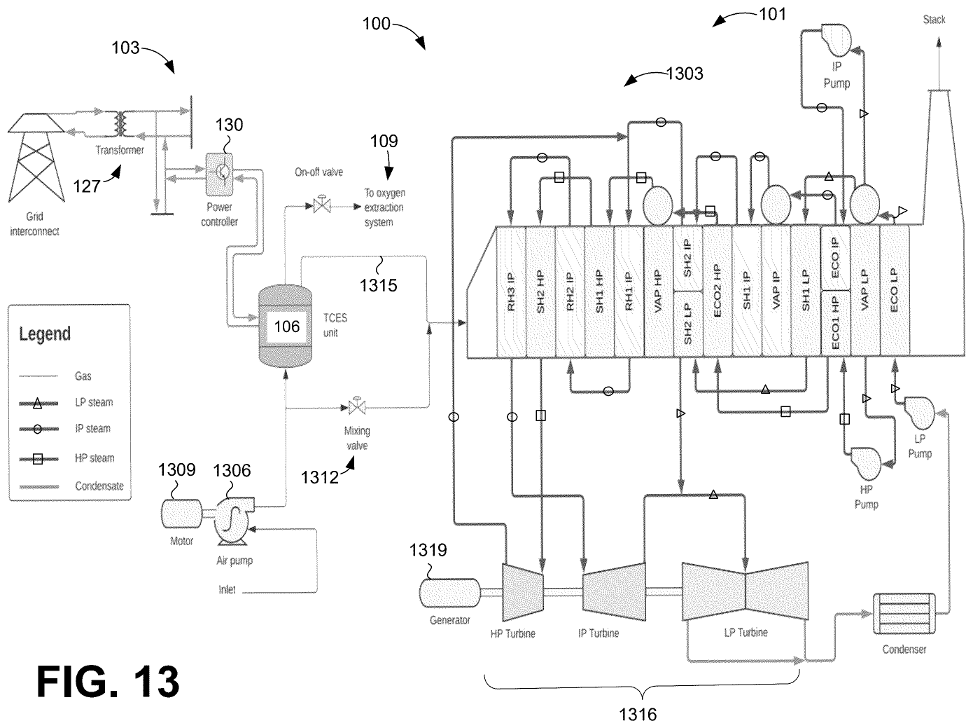

Moving to FIG. 13, shown is another example of the power generation system 101 in the network environment 100. In this example, the power generation system 101 includes the TCES device 106, a steam generator system 1303, an air pump 1306, a motor 1309, a mixing valve 1312, an oxygen extraction system 109, and other suitable components. The steam generator system 1303 can include a steam turbine 1316 (e.g., referencing one or more of a high pressure (HP) turbine, an intermediate pressure (IP) turbine, a low pressure (LP) turbine in FIG. 13), an electrical generator 1319, and other suitable components. With multiple pressure levels you can either have multiple steam turbines connected to the same shaft.

In one embodiment, the electrical grid infrastructure 103 includes, for example, a power transformer 127 connected to a power controller 130. The power transformer 127 adjusts the line voltage to the required value by the TCES device 106. The power controller 130 is configured to input a controlled amount of electricity into the TCES device 106, ultimately heating the reactive material via Joule heating according to a prescribed power rating. In one embodiment, the power controller 130 is an AC-DC controlled multi-pulse rectifier relying on either thyristors (also known as silicon controlled rectifiers, SCRs) or insulated-gate bipolar transistors (IGBTs) as semiconductor switches. In another embodiment, the power controller 130 is an AC-AC controlled thyristor system operating, for example, in either phase angle mode, full wave burst mode, or half-wave mode. In another embodiment, the power controller 130 is an on-load tap changer (OLTC) that, via either mechanical or semiconductor switches, automatically selects the appropriate secondary winding of the power transformer 127 depending on the voltage requirements of the TCES device 106. The oxygen extraction system 109 is configured to remove oxygen from the interior volume of the TCES device 106 when the reactive material is heated.

Unlike in the gas turbine retrofit application (see e.g., FIGS. 1-5), the illustrated power generation system 101 of FIG. 13 can be configured for slightly above atmospheric pressure operation (below 2 bar absolute, for example), significantly reducing the containment shell costs and requirements. The air handling device is now a low-pressure air pump 1306 instead of a high-pressure compressor unit (see e.g., FIGS. 1-5).

Upon the discharge of the power generation system 101 by way of the TCES device 106, the TCES device 106 provides high-temperature oxygen-deficient air to the steam generator system 1303 at temperatures up to 1500° C., for example. The temperature entering the HRSG must be controlled by the mixing valve 1312 to the maximum value for which the HRSG is rated, usually no more than 650-700° C., for example. In another variant of FIG. 13, the mixing valve 1312 can be replaced by a second blower system (that processes ambient temperature air) that is connected to the outlet of the TCES device 106. The steam generator system 1303 can either be of sub-critical or super-critical type. In a sub-critical steam generator unit, the heat exchanged with the economizers, vaporizers, superheaters and re-heaters, will generate high-pressure steam, either in saturated or superheated form, that can be expanded in the steam turbine. Multiple steam pressure level configurations can be adopted. The mechanical power produced by the steam turbine 1316 is then converted into electrical power via the electrical generator 1319.

Upon charging the power generation system 101 by way of the TCES device 106, different operational strategies are possible. In one embodiment, the high-temperature oxygen released by the TCES device 106 is exhausted into the atmosphere. One of the oxygen extraction systems 109 described above (see e.g., FIGS. 6-12) can be used. During a time period of a charging mode for the TCES device 106 of the power generation system 101 for FIG. 13, no electrical power is generated by the electrical generator 1319.

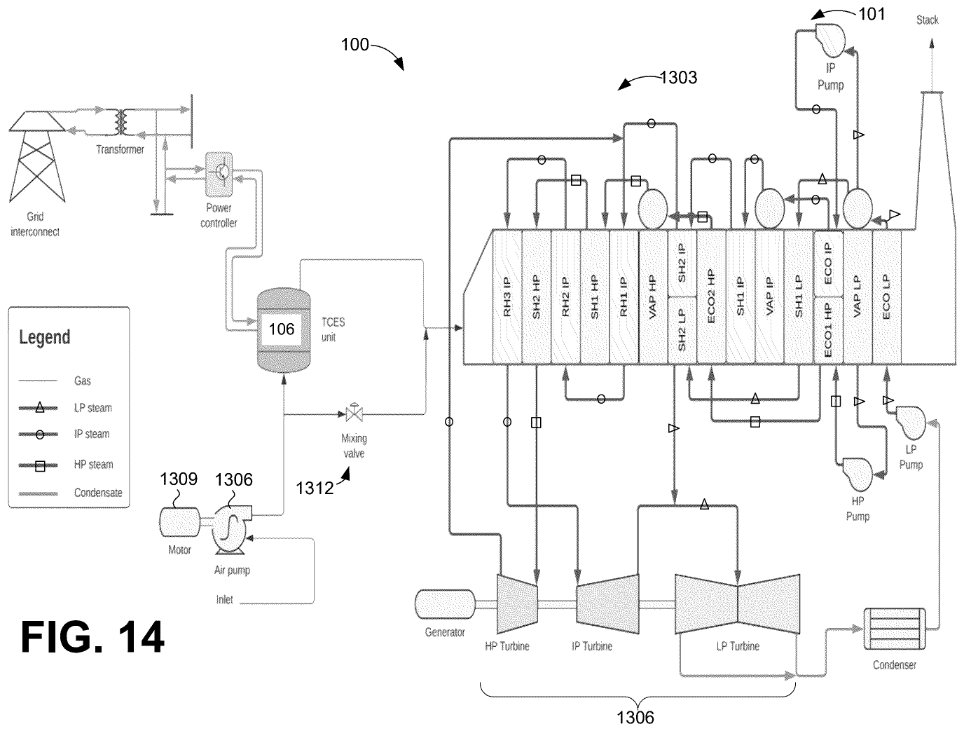

FIG. 14 illustrates the power generation system 101 where the oxygen extraction system 109 is omitted. In this example, the high-temperature oxygen released by the TCES device 106 can be mixed with ambient air (e.g., via the mixing valve 1312 and the air pump 1306) to achieve a controlled gas temperature between 400 and 1000° C., for example. In another variant of FIG. 14, the mixing valve 1312 can be replaced by a second blower system (that processes ambient temperature air) that is connected to the outlet of the TCES device 106.

The blended gas can then be introduced into the steam generator system 1303 for electrical power generation. This configuration, as shown in FIG. 14, has at least the following advantages 1) allows to generate electrical power during a charging mode of the TCES device 106, 2) maximizes system efficiency and TCES utilization, 3) avoids the need of the oxygen extraction system 109 (see e.g., FIG. 13), and 4) maintains the steam generator system 1303 at elevated temperatures, reducing the low cycle thermal fatigue due to otherwise frequent start-stop cycles.

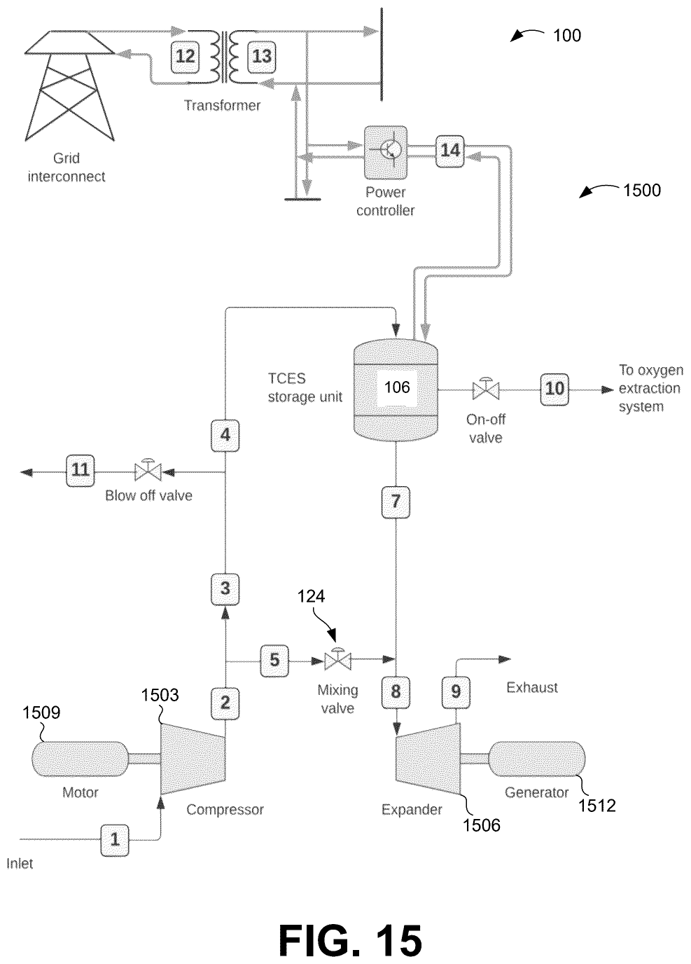

FIG. 15 illustrates the power generation system 1500 where the shaft 119 is omitted (e.g., as shown in FIG. 1). In FIG. 15, the power generation system 1500 includes a compressor 1503, an expander 1506, the electrical motor 1509, the electrical generator 1512, and other suitable components. Unlike with the gas turbine variant, in this embodiment the compressor 1503 and the expander 1506 do not share a common shaft. The compressor 1503 is driven by the electrical motor 1509 and the expander 1506 drives the electrical generator 1512.

The compressor 1503 can be a turbomachine or a volumetric machine. In the case where the compressor is a turbomachine the compressor 1503 can be a radial compressor, an axial compressor, or a mixed flow compressor, for example. In the case where the compressor is a volumetric machine, it can be a reciprocating compressor, a vane compressor, a screw compressor, a Roots compressor, a liquid ring compressor, for example. The compressor 1503 can be in single or multi-stage configuration, with or without intercooling between compression stages.

The expander 1506 can be a turbomachine or a volumetric machine. In the case the expander is a turbomachine, it can be a radial expander, an axial expander, or a mixed flow expander, for example. In the case the expander is a volumetric machine, the expander 1506 can be a piston expander, a vane expander, a screw compressor, a scroll expander, for example. The expander unit can be in single or multi-stage configuration, with or without heat addition heat exchangers between expansion stages. In this example, the power generation system 101 of FIG. 15 preserves the mixing valve 124 to control the temperature at the inlet of the expander 1506 by mixing an appropriate fraction of the compressed air.

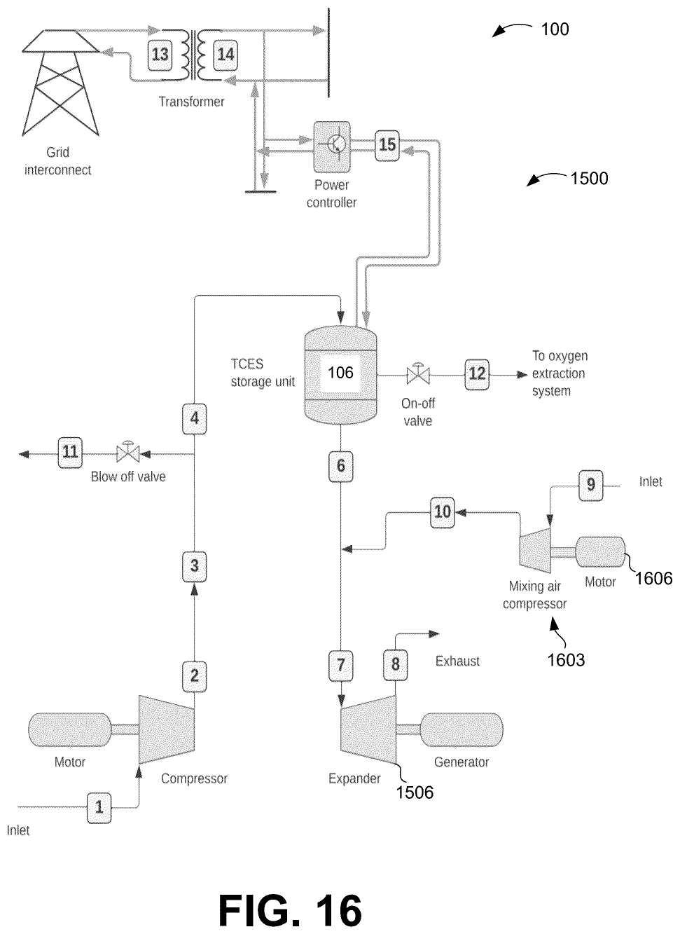

FIG. 16 illustrates that the power generation system 1500 in which the mixing valve 124 (see e.g., FIG. 15) is omitted and replaced with a mixing air compressor 1603 connected to an outlet of the TCES device 106. This mixing air compressor 1603 has the same purpose of the mixing valve 124, i.e. to reduce the outlet temperature of the TCES device 106 to a value that can be managed by the inlet of the expander 1506. The mixing air compressor 1603 is driven by a separate electrical motor 1606. The mixing air compressor 1603 can be a turbomachine or a volumetric machine. In the former case of a turbomachine, the mixing air compressor 1603 can be a radial compressor, an axial compressor, or a mixed flow compressor, for example. In the latter case of a volumetric machine, the mixing air compressor 1603 can be a reciprocating compressor, a vane compressor, a screw compressor, a Roots compressor, a liquid ring compressor, for example. The mixing air compressor 1603 unit can be in single or multi-stage configuration, with or without intercooling between compression stages.

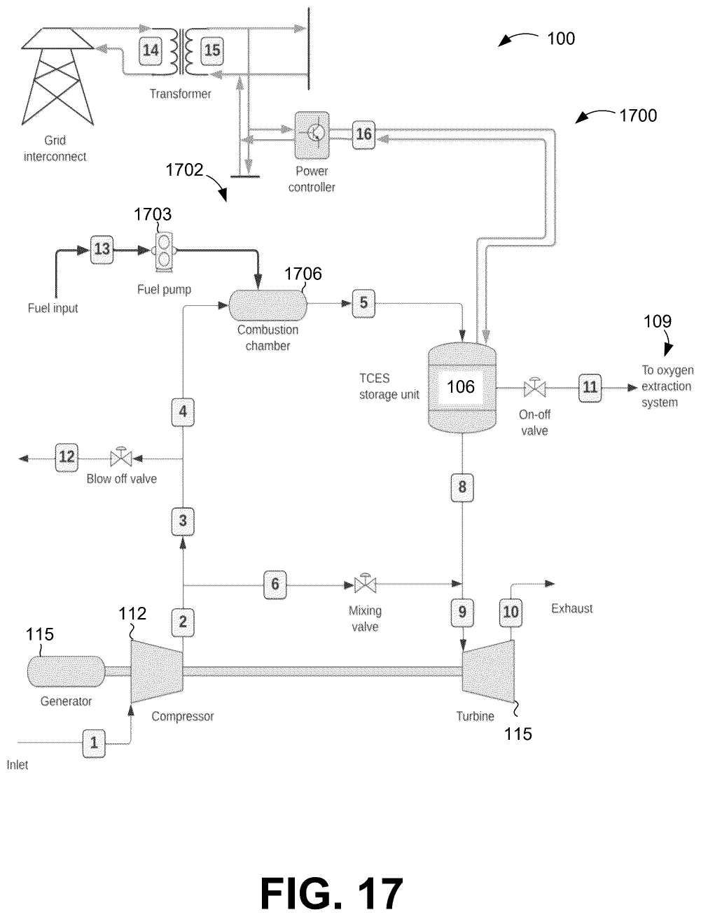

Next, FIG. 17 illustrates a power generation system 1700 in the network environment 100. The power generation system 1700 includes a co-firing system 1702 and other suitable components. In some examples, the power generation system 1700 can represent a simple cycle gas turbine plant with a single mixing value with the integration of the co-firing system 1702 and the TCES device 106. The co-firing system 1702 includes a fuel pump 1703, a combustion chamber 1706, and other suitable components.

As a variant to the gas turbine-based options presented in FIGS. 1-5, 13, and 14, the fuel co-firing system 1702 can be added. Gas turbine systems already come with a set of fuel combustors. The combustors (e.g., combustion chamber 1706) can be arranged in different configurations: single-can, multi-can, can-annular, annular, silo, for example. In the co-firing system 1702, for example, the combustion chamber 1706 can be kept in the integrated system flow path and, when needed, their fuel combustion systems can be activated to provide additional external heat input to the power plant. Most heavy-duty gas turbines have a multi-can combustor configuration in which the compressed airflow enters multiple combustion chambers (6, 12, or 18 combustion chambers, for example). In one embodiment, only a fraction of these combustion chambers 1706 can be connected to the fuel line (e.g., line 13 in FIG. 17).

This co-firing operating mode adds operational availability to the power plant as it guarantees consistent electrical power output in case of a 1) TCES device malfunction, 2) an electrical infrastructure malfunction (a grid outage, for example), or 3) if it is not economically convenient to operate the TCES unit (due to excessive electricity prices, for example), for example.

In normal operating conditions, the co-firing mode can provide economic benefits as fuel can be burned when electricity prices for charging the TCES device 106 are high relative to the fuel costs. Any fuel type can be used in principle as long as the gas turbine combustor is rated for it. The most common fuels include natural gas, methane, bio-fuels, hydrogen, ammonia, and their blends, among others.

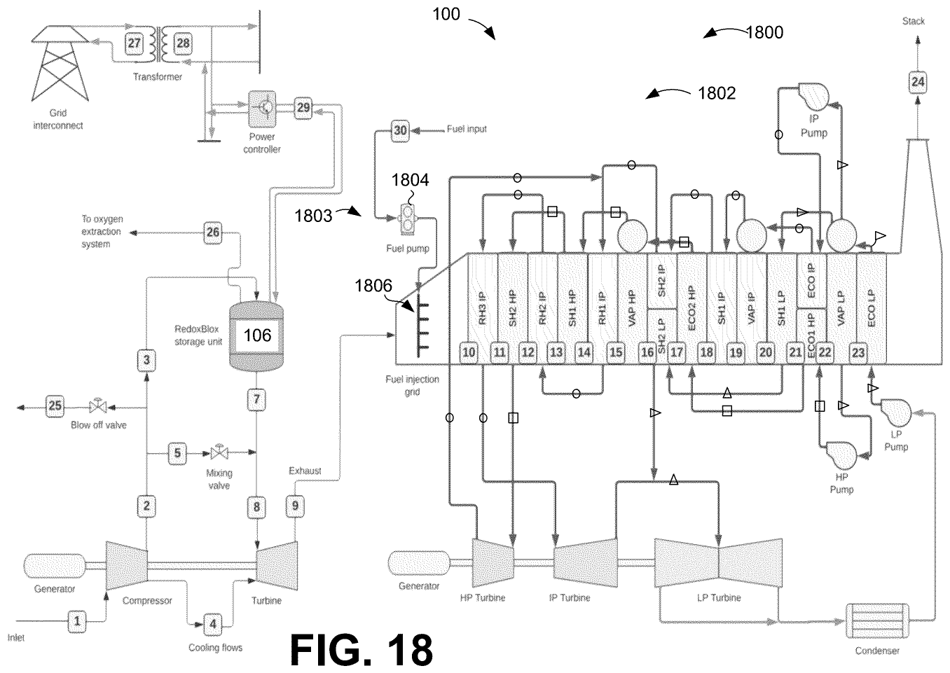

Moving to FIG. 18, shown is a power generation system 1800 that includes a steam generator system 1802 with an integrated co-firing system 1803. The co-firing system 1803 can include a fuel pump 1804 and a fuel injection grid 1806. In the illustrated example, the fuel injection grid 1806 is integrated within the steam generator system 1802, in which the fuel pump 1804 is in fluid connection with the fuel injection grid 1806.

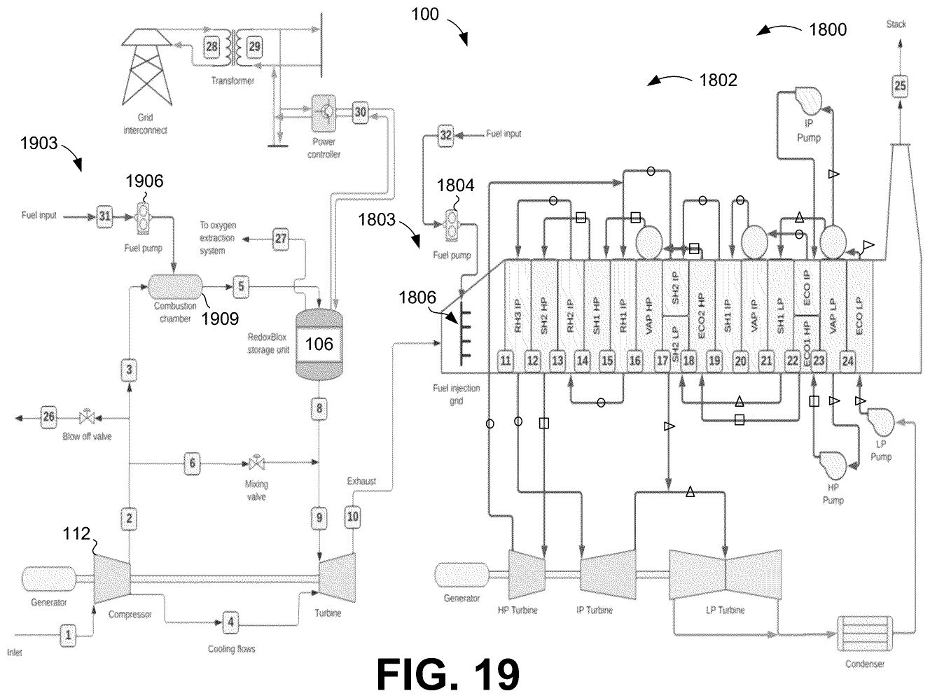

FIG. 19 illustrates a power generation system 1800 that includes a second co-firing system 1903. The second co-firing system 1903 includes a second fuel pump 1906 and a combustion chamber 1909. The combustion chamber 1909 is in fluid connection with the TCES device 106 and the compressor 112.

As such, with respect to the combined cycle variant described in FIG. 5, the fuel co-firing option can be added either within the steam generator system 1802 (e.g., heat recovery steam generator), as shown in FIG. 18, or also within the simple cycle gas turbine section, as shown in FIG. 19. Similar co-firing options can be added to the variants described for FIG. 13-16.

In all these variants, co-firing via an additional combustion chamber can take place either with a combustion chamber placed in series or in parallel to the TCES device 106, for example, providing equivalent performance and reliability benefits.

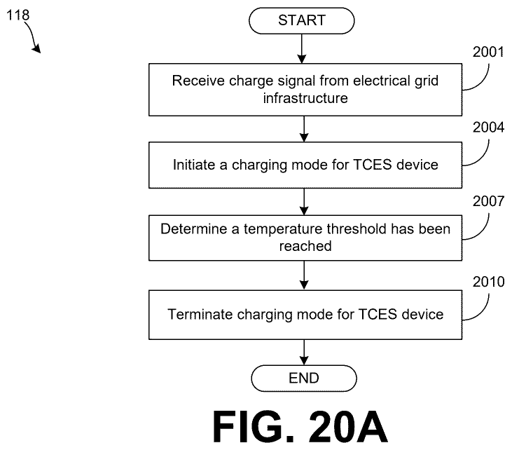

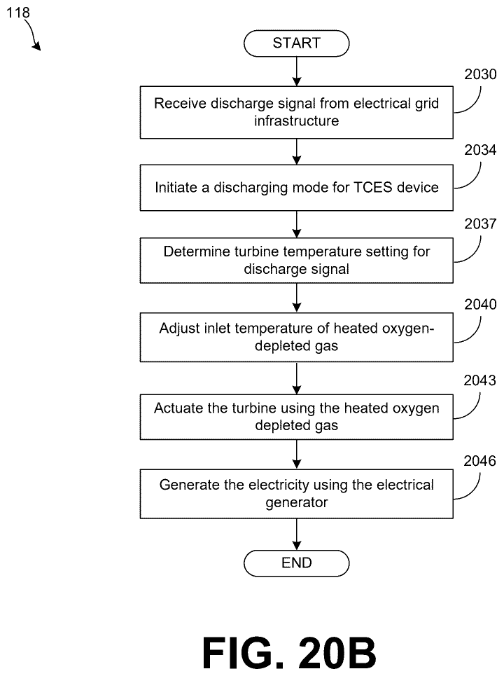

Referring next to FIG. 20A, shown is a flowchart that provides one example of a charging mode of operation controlled by the controller 118 for a power generation system. The flowchart of FIG. 20A provides merely an example of the many different types of functional arrangements that can be employed to implement the operation of the depicted portion of the controller 118. As an alternative, the flowchart of FIG. 20A can be viewed as depicting an example of elements of a method implemented within the network environment 100. Although controller 118 is not shown in all figures, it is understood that the controller 118 can be employed to control the various embodiments in the present disclosure. The controller 118 can operate the power generation system in various modes, such as a charging mode, a discharging mode, a charging while simultaneously discharging mode, and other suitable modes. In some examples, the controller 118 can provide instructions to the TCES device 106 or the TES device. The TES device or TCES device 106 can be configured to increase the thermal energy storage capacity or the thermochemical energy storage capacity of the device by passing an electrical current directly through the energy storage material. It should be noted that the description below can be applied to the TCES device 106 or the TES device.

Beginning with block 2001, the controller 118 receives a charge signal from the electrical grid infrastructure 103. In some instances, the charge signal is transmitted by the power controller 130 to the controller 118. The charge signal can represent an availability of the electrical grid infrastructure 103 to supply the electricity to the TCES device 106 (or TES device), a scheduled request to charge at a particular day and time, a requested charge time period, a requested charge power level, and other suitable charge signal indicators. For instance, the electrical grid infrastructure 103 (e.g., power controller 130) can determine dynamically at any point of time that there is excess electricity in the electrical grid infrastructure 103 and transmit the charge signal to the system 101 or other power generation systems described in the present disclosure in order to convert the excess electricity to thermochemical energy that is stored within the TCES device 106 (or to sensible thermal energy that is stored within the TES device).

In another example, the power controller 130 can determine to instruct the system 101 to initiate a charge mode operation based, at least in part, on one or more of various conditions and factors. For example, the power controller 130 can initiate a charge signal, based at least in part, on a production demand schedule, an energy price, or other suitable factors. In yet another example, the controller 118 can determine to initiate a charge signal to the TCES device 106 (or TES device), based at least in part, on one or more factors independent of or in combination with data from the power controller 130. For example, the controller 118 can receive a temperature measurement of the TCES device 106 (or TES device) that is below a minimum temperature threshold for an interior of the TCES device 106 (or TES device). As such, the controller 118 can initiate a charge signal. In this example, the charge signal can be configured for charging for a particular temperature, an amount of charged time, or other suitable conditions.

In block 2004, the controller 118 initiates a charging mode for the TCES device 106. In some examples, the controller 118 initiates the charging mode based at least in part on the charging signal. In some examples, when the charging mode is initiated, it causes the electrical current to pass directly through the energy storage material. For example, the TCES device 106 (or TES device) can receive electricity directed by the power controller 130 from the electrical grid infrastructure 103. The electricity is used to heat an energy storage material, or other suitable material, within the TCES device 106 (or TES device) by passing an electrical current directly through the energy storage material. Further, when using a TCES device 106, the controller 118 can instruct the oxygen valve 121 to adjust to an open state for the oxygen extraction system 109.

The charging signal can include instructions or information that are extracted by the controller. For example, the charging signal can indicate a time period for starting the charging mode, such as an immediately, at a scheduled time, based at least in part on one or more conditions, and/or other suitable factors. In some examples, the charge signal represents an instruction for operating the charging mode while simultaneously operating a discharging mode for discharging the heated gas out of the TES device or the TCES device.

In some example configurations, the compressor may provide different gases (e.g., air, any oxygen-containing gas, or nitrogen) for different modes of operations. For example, during a charging mode, the compressor can provide nitrogen gas to the interior volume in order to improve the performance of the charging operation by facilitating a better reduction reaction. Subsequently, the compressor can provide an oxygen-containing gas during a discharge mode (FIG. 20B).

In block 2007, the controller 118 determines a temperature threshold for the TCES device 106 (or TES device) has been reached. After the charging mode of the TCES device 106 has been initiated, the heated oxygen gas is generated within the interior volume of the TCES device 105. A temperature sensor within the interior volume can measure the temperature of the oxygen gas and determine when a temperature threshold has been reached. The temperature sensor can provide the temperature measurements to the controller 118 or other components within the power generation system 101. The temperature threshold can represent an indication that the TCES device 106 (or TES device) has reached a charging limit or a desired charging limit.

In some examples, the controller 118 can determine a temperature threshold for the charging signal. For instance, the charge signal may indicate a requested power level. As a result, the requested power level may not need a full charge for the TCES device 106 (or TES device). Accordingly, the controller 118 can determine a temperature threshold that corresponds to the required power level. In yet another example, the controller 118 determines a threshold has been reached for another parameter associated with TCES device 106 (or TES device), which can indicate that the TCES device 106 (or TES device) has reached a charging limit or a desired charging limit.

In block 2010, the controller 118 terminates the charging mode for the TCES device 106 (or TES device) based at least in part on the temperature threshold being reached for the TCES device 106 (or TES device). Upon reaching the temperature threshold or other charging limit, the controller 118 can instruct components of the power generation system 101 for terminating operations for generating additional heat in the interior volume of the TCES device 106 (or TES device). Then, the controller 118 can proceed to the end.

Referring next to FIG. 20B, shown is a flowchart that provides one example of a discharging mode of operation controlled by the controller 118. The flowchart of FIG. 20B provides merely an example of the many different types of functional arrangements that can be employed to implement the operation of the depicted portion of the controller 118. As an alternative, the flowchart of FIG. 20B can be viewed as depicting an example of elements of a method implemented within the network environment 100. Although controller 118 is not shown in all figures, it is understood that the controller 118 can be employed to control the various embodiments in the present disclosure. The controller 118 can operate the power generation system in various modes, such as a charging mode, a discharging mode, a charging while simultaneously discharging mode, and other suitable modes. In some examples, the controller 118 can provide instructions to the TCES device 106 or a TES device. The TES device or TCES device 106 can be configured to increase a thermal energy storage capacity or a thermochemical energy storage capacity by passing an electrical current directly through the energy storage material. It should be noted that the description below can be applied to the TCES device 106 or a TES device

Beginning with block 2030, the controller 118 receives a discharge signal from the electrical grid infrastructure 103. In some instances, the discharge signal is transmitted by the power controller 130 to the controller 118. The discharge signal can represent a request for the system 101 or other power generation system described in the present disclosure to generate electricity, a scheduled request to generate electricity at a particular day and time, a requested time period for generating electricity, a requested discharge power level, and other suitable discharge signal indicators. For instance, the electrical grid infrastructure 103 (e.g., power controller 130) can determine dynamically at any point of time that there is a demand for electricity in the electrical grid infrastructure 103 and can transmit the discharge signal to the system 101 or other power generation systems described in the present disclosure in order generating electricity for the electrical grid infrastructure 103. In another example, the power controller 130 can determine to instruct the system 101 to initiate a discharge mode operation based at least in part on or more of various conditions and factors. In yet another example, the controller 118 can determine to generate a discharge signal independent of the electrical grid infrastructure 103.

In block 2034, the controller 118 initiates a discharge mode of operation for the TCES device 106 (or TES device). The initiation of the discharge mode can include activating a motor to begin spinning a shaft 119 (e.g., FIG. 1) attached to the compressor 112, the turbine 115, a heat engine, and/or other suitable power generation systems. Further, the discharging mode includes supplying the compressed air to the TCES device 106 from the compressor 112 and discharging the heated oxygen-depleted gas to the turbine 115. Thus, the discharging mode can instruct or cause the TCES device 106 (or the TES device) to discharge heated gas. In some examples, when a TES device is used, TES device can discharge heated/air (e.g., high temperature air) to the turbine 115 instead of an oxygen-depleted gas. The heat engine is a device that converts thermal energy (heat) into mechanical power, electrical power, and other suitable forms of power. The heat engine can represent an electrical generation system (e.g., a turbine, a compressor, a generator), a steam engine, another mechanical system (e.g., a combustion engine, a mechanical driven system, etc.), and other suitable power systems. For example, the heat engine can power an electrical generator.

In block 2037, the controller 118 determines a turbine temperature setting or a heat engine temperature setting for the discharge signal. In some examples, the discharge signal includes a requested power level. The requested power level can be used to determine the heat engine or the turbine temperature setting. For example, if the nominal turbine inlet temperature is setting is chosen, this equates to requesting 100% of the nominal power output. Any temperature setting less than the nominal can result in lower power output.

In block 2040, the controller 118 adjusts an inlet temperature of the heated oxygen depleted gas discharged from the TCES device 106 (or heated/high-temperature air (non-oxygen deprived) for a TES device) to the heat engine setting or turbine temperature setting. In some examples, the controller 118 can adjust the inlet temperature by actuating a mixing valve 124 in order to mix a portion of the compressed air from the compressor 112 with the discharged heated oxygen depleted gas from the TCES device 106 until the inlet temperature of the heated oxygen-depleted gas matches the turbine temperature setting.

In block 2043, the controller 118 causes the actuation of the heat engine or the turbine 115 using the heated oxygen-depleted gas at the temperature setting. The heat engine or the turbine 115 can be actuated directly or indirectly using the heated gas. For example, the heated oxygen-depleted gas can actuate (e.g., rotate) one or more mechanical components of the turbine 115 or the heat engine. In some examples, the actuation of the mechanical components can cause the rotation of a shaft attached to the turbine 115 or the heat engine.

In block 2046, the controller 118 can cause the generation of the electricity using the electrical generator 116. In some examples, the shaft attached to the turbine 115 is also attached to the electrical generator 116. As such, the rotation of the shaft attached to a portion of the electrical generator 116 can be used to generate electricity. The generated electricity can be supplied to the electrical grid infrastructure 103, or other suitable loads. In the context of the present disclosure for FIGS. 20A and 20B, oxygen depleted gas can represent no oxygen or an oxygen concentration that is below a threshold or within a threshold range (e.g., between 20% and 25% by volume, or between 15% and 25% by volume, or between 10% and 25% by volume, or between 5% and 25% by volume, or between 0% and 25% by volume). The oxygen-depleted gas can be used in the TCES device 106 or the TES device, in which the oxygen-depleted gas can be air.

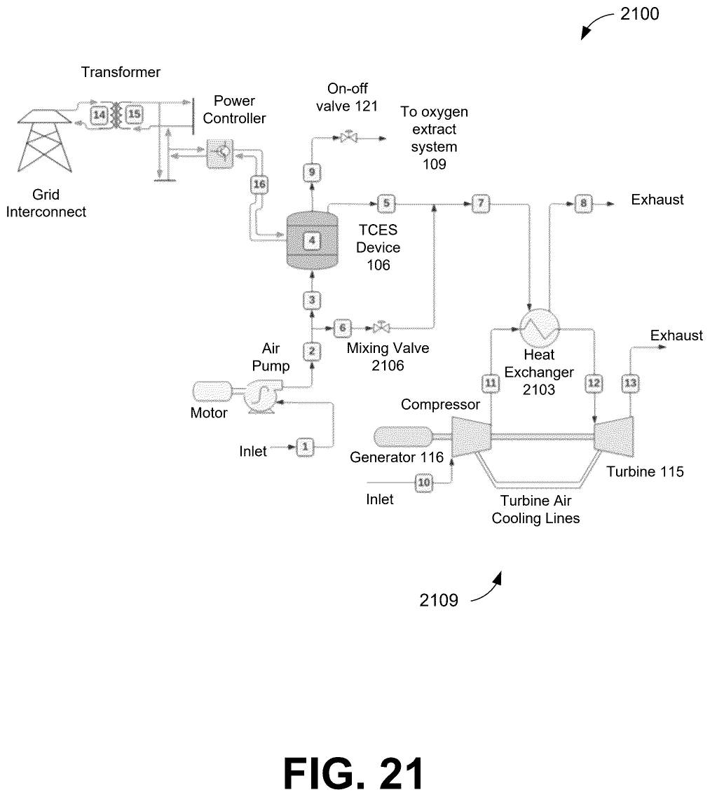

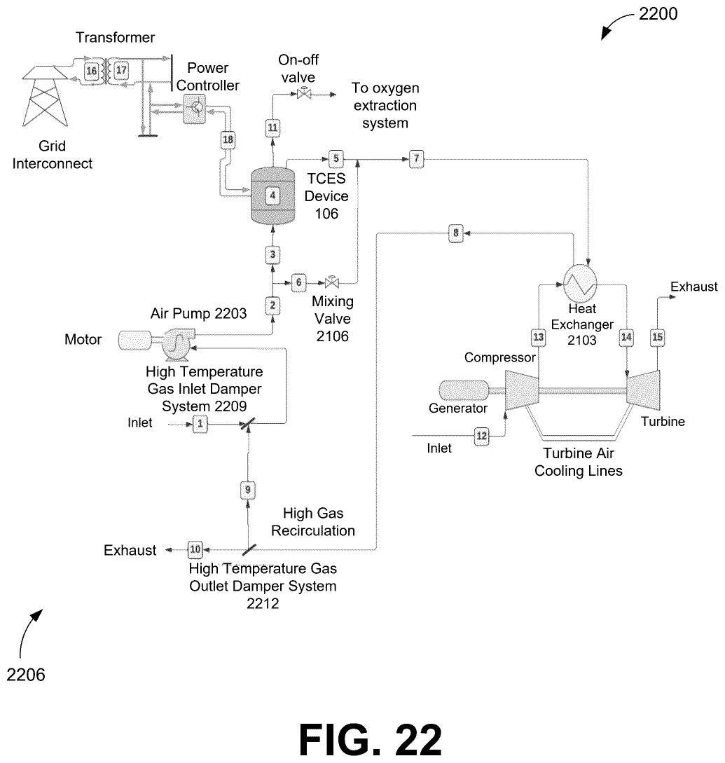

FIGS. 21 and 22 are drawings depicting examples of a power generation systems 2100 and 2200 with a heat exchanger 2103. These are additional configurations to what was described in FIGS. 1-5. These configurations use an intermediate high-temperature heat exchanger 2103 to input heat into the gas turbine cycle of the turbine 115 (or a heat engine). The configurations described below share the following advantages:
The TCES device 106 (or TES device) can be designed for a different operating pressure than the compressor discharge pressure.
   This enables one TCES device (or TES device) design for multiple gas turbine systems (which would each have different pressure requirements)
   The TCES device 106 (or TES device) can be designed for operation at close to atmospheric pressure, significantly reducing system cost
The oxygen extraction system operation is decoupled from gas turbine operation
TCES device startup sequence (e.g., energy storage material pre-heating), if needed, is decoupled from the gas turbine flow path
The high-temperature, high-pressure mixing valve controlling the turbine inlet temperature is no longer needed. This further reduces cost as less components are needed and fewer modifications to the main gas turbine architecture are required
Gas turbine performance is unaffected by the change in mass flow rate due to the chemical oxidation taking place during TCES discharge

In another variant of FIGS. 21 and 22, the mixing valve 2106 can be replaced by a second blower system (that processes ambient temperature air) that is connected to the outlet of the TCES device 106 (or TES device).

In one embodiment, the TCES device 106 (or TES device) is coupled with a simple cycle gas turbine plant as shown in FIG. 21. Upon TCES device 106 discharge, the on/off oxygen valve 121 after 9 is closed and the oxygen extraction system is inactive. The gas turbine 2109 (or a heat engine) is started by operating the generator in “motor mode”. The high-temperature gas exiting the TCES device 106 (or TES device) is mixed with the ambient temperature air to gradually increase the turbine inlet gas temperature (line 12). When the turbine inlet temperature (line 12) is sufficiently high, the gas turbine 2109 achieves its self-sustaining speed and the “motor mode” on the electrical generator 116 is switched back to “generator mode”. The mixing valve 2106 on line 6 ensures that the turbine inlet temperature (line 12) of the turbine 115 (or a heat engine) never exceeds the nominal turbine inlet temperature value for the specific gas turbine engine. No air bypass takes place (mixing valve fully closed) when the temperature at line 12 is below the nominal turbine inlet temperature. The mixing valve 2106 can be, for example, a butterfly valve, a ball valve, a segmented ball valve, a globe valve, a diaphragm valve, a globe valve, an angle valve, a gate valve, a needle valve, a plug valve, a pinch valve, among others. In another variant of FIG. 21, the mixing valve 2106 can be replaced by a second blower system (that processes ambient temperature air) that is connected to the outlet of the TCES device 106.

The heat exchanger 2103 (between lines 7, 8, 11, 12) can be a tubular heat exchanger, a shell-and-tube heat exchanger, a fin-tube heat exchanger, a plate-type heat exchanger, an extended surface heat exchanger, a spiral heat exchanger, a pipe-in-pipe heat exchanger, a micro-channel heat exchanger, a compact heat exchanger, among others. The heat exchanger 2103 transfers heat from the TCES device 106 (or TES device) output gas (line 7) to the gas turbine compressor discharge gas (line 11).

A variation of the embodiment in FIG. 21 is shown in FIG. 22 for power generation system 2200, in which the hot gas exiting the heat exchanger 2103 (line 8) is recirculated back towards the inlet of the TCES device 106 (or TES device). When 106 is a TCES device, in order to keep the correct oxygen balance, a certain amount of ambient air must be introduced at the inlet of the TCES device 106. In this case, the air pump 2203 is rated to the design recirculation temperature. The power generation system 2200 in FIG. 22 includes a damper system 2206 that supplies recirculated heated gas to the TCES device 106 (or TES device). In some examples, the damper system 2206 recirculates heated gas by supplying at least a controlled amount of heated gas from the heat exchanger and in some examples, a controlled amount of inlet ambient air.

In some implementations, the damper system 2206 can include an inlet damper system 2209 and an outlet damper system 2212. A controlled inlet damper system 2209, or an equivalent device or set of devices in terms of function, can be present to control the amount of recirculation. Including exhaust gas recirculation allows to increase the overall thermal efficiency of the system. The inlet damper system 2209 can provide a controlled amount of an inlet ambient air, in which the controlled amount can include a no flow of ambient air or at least some flow of ambient air. A controlled outlet damper system 2212, or an equivalent device or set of devices in terms of function, can be installed to determine the amount of exhaust gas recirculation. In another variant of FIG. 22, the mixing valve can be replaced by a second blower system (that processes ambient temperature air) that is connected to the outlet of the TCES device 106 (or TES device).

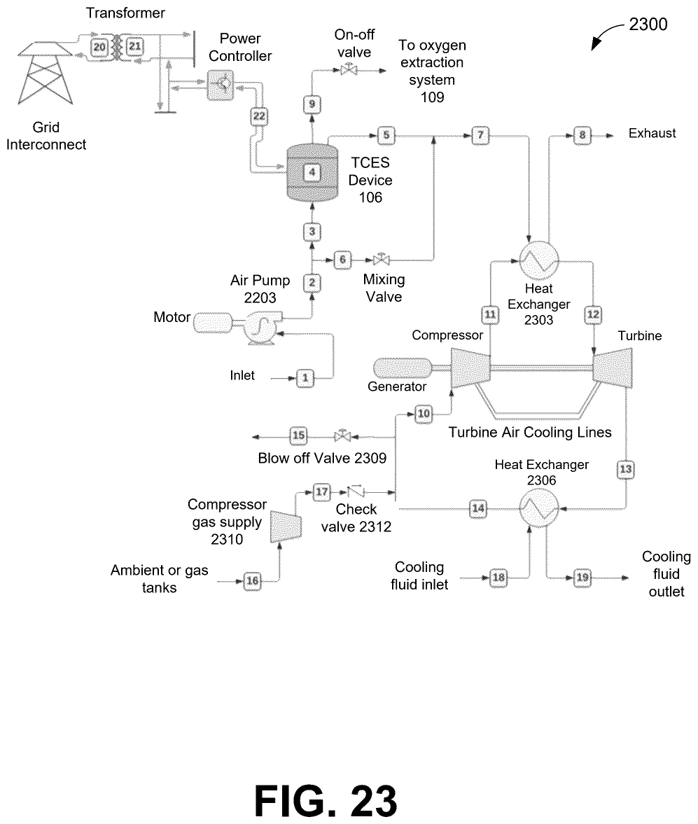

FIG. 23 is a drawing depicting an example of a power generation system 2300 with a heat exchanger for closed cycle gas turbines according to one example of the present disclosure. The possibility of adopting an intermediate high-temperature heat exchanger configuration as shown in FIGS. 21 and 22, enables to alter the gas turbine cycle configuration towards a closed cycle configuration.

A closed cycle gas turbine cycle has, among others, the following differences over an open cycle gas turbine cycle:
The heat injection takes place via a high-temperature heat exchanger 2303
Turbine exhaust gas is recirculated back to the compressor inlet. A low-temperature heat exchanger 2306 is used to reduce the turbine exhaust gas temperature to an appropriate value at the compressor inlet.
System power output is altered via changing the system pressure via a compressor gas supply. A blow-off valve 2309 can be used to control the mass flow rate and working pressure in the gas turbine cycle.
The cycle can be operated at constant turbine inlet temperature and compressor pressure ratio across the entire load range, thus allowing for higher thermal efficiencies across the entire load range.
The working pressure at the compressor inlet can be higher than atmospheric pressure. This reduces the size of the turbomachinery components.
The working fluid is not limited to air. Other gases with better thermal properties (e.g., helium) can be used instead for increase in thermal efficiency.

In one embodiment, the TCES device 106 (or TES device) is coupled with a closed cycle gas turbine plant as shown in FIG. 23. The working fluid within the gas turbine cycle is circulating in a closed loop. Power output can be controlled either by 1) changing the turbine inlet temperature (line 12), 2) changing the baseline working fluid pressure (line 10) via a compressor gas supply 2310 (between line 16 and line 17), and/or 3) changing the circulating mass flow rate through the blow off valve (line 15), for example. The check valve 2312 (line 17) ensures that no backflow through the compressor gas supply 2310 occurs during normal operating conditions. The system operation on the TCES device 106 (or TES device) side is similar to what described in FIG. 21.

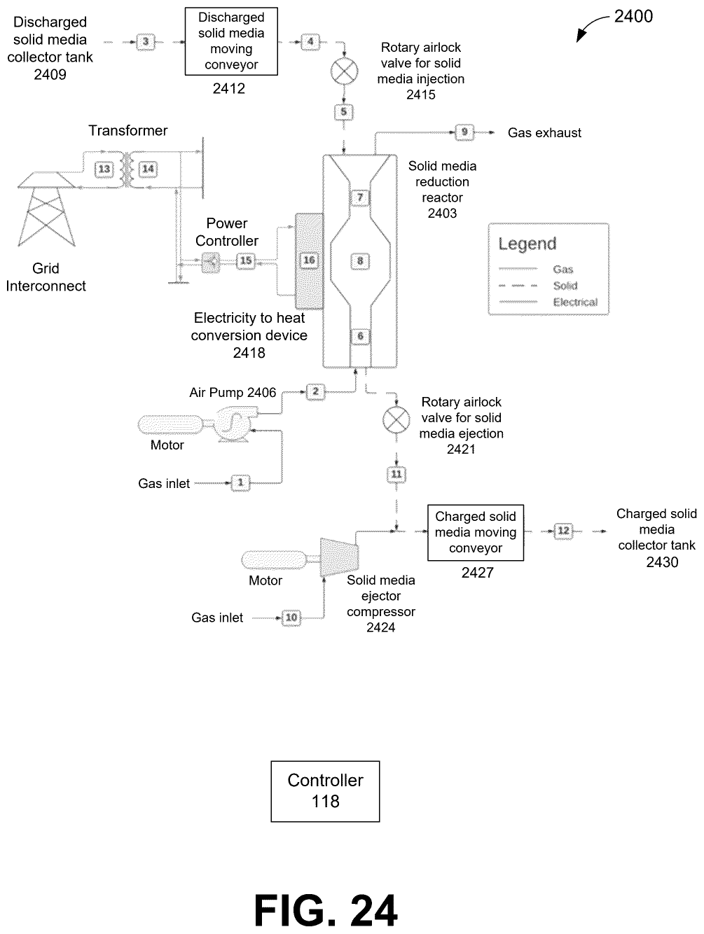

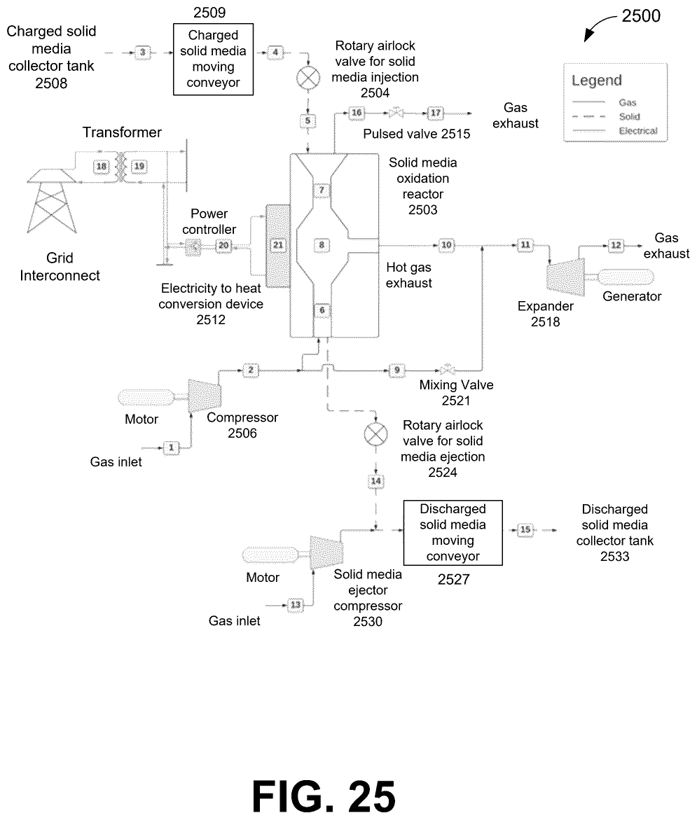

FIG. 24 is a drawing depicting a power generation system 2400 using a reduction reactor 2403 according to one example of the present disclosure. The reduction reactor system 2403 for FIG. 24 is based on the use of a solid-state thermochemical energy storage media that can be stored at ambient conditions in its charged and discharged states when not in use without loss in energy storage potential. The solid-state energy storage media is chemically charged in a “reduction reactor” 2403 and stored in the charged state at ambient temperatures and pressures. Once thermal power is needed, the charged fuel is discharged through an “oxidation reactor” 2503 (FIG. 25). The fuel in the discharged state can be stored at ambient temperatures and pressures, and subsequently recharged in the “reduction reactor” 2403.

The “oxidation reactor/s” 2503 and “reduction reactor/s” 2403 can be either co-located or located in different sites. The fact that the solid media can be stored at ambient temperature and pressures facilitates low-cost storage and transportation.

### Reduction Reactor Description

A possible embodiment of the reduction reactor 2403 is shown in FIG. 24. Low-pressure, atmospheric temperature gas is flown through the reduction reactor 2403 via an air pump 2406 (lines 1-2-6-8-7-9). The air pump 2406 can be a turbomachinery or a volumetric machine. In the former case, it can be a radial compressor, an axial compressor, or a mixed flow compressor, for example. In the latter case, it can be a reciprocating compressor, a vane compressor, a screw compressor, a Roots compressor, a liquid ring compressor, for example. The air pump unit can be in single or multi-stage configuration, with or without intercooling between compression stages.

The discharged solid media from a collector tank 2409 is fed to the top of the reduction reactor 2403 through a moving conveyor system 2412. A rotary airlock valve 2415 (or equivalent solid media injection system) is used to feed the discharged solid media into the top of the reduction reactor 2403 (line 7).

Electricity (or equivalent means, such as a solar concentrator, for example) is used to heat the central section of the reduction reactor 2403 (line 8) to high temperatures (between 100° and 1500° C., for example) via, for example, an electricity to heat conversion device 2418 (line 16). The higher the furnace temperature, the lower the residence time needed by the solid media particles to achieve their maximally charged (reduced) state.

The reduction reactor 2403 can include a quenching zone (line 6), a recuperation zone (line 7), a reduction furnace (line 8), and other suitable components. When the gas and the discharged solid media interact in the reduction furnace (line 8), they exchange heat and oxygen, promoting the chemical endothermic reduction reaction of the solid media, which is accompanied by a release of oxygen. The solid media exits the reduction furnace (from line 8) at high temperatures. It is then quickly quenched in the quenching zone (line 6) by the incoming cold gas. The upward moving high temperature gas exiting the reduction furnace (from line 8), instead, enters the recuperation zone (line 7) in which it gives off heat to the incoming discharged solid media. As an outcome of this internal heat recuperation, both the gas and the solid media enter and exit the solid media reduction reactor at close to ambient temperatures. This avoids the handling of high-temperature solids and gases as well as high-temperature sealing issues. Oxygen rich gas exits through line 9 at close to ambient temperatures.

The now chemically charged particles exit through the quenching zone (line 6) via a rotary airlock valve 2421 (or equivalent solid media ejection system). To allow for storage of the charged solid media, a solid media ejector compressor 2424 (after line 10) is activated at fixed or continuous time intervals to push the charged solid fuel towards a moving conveyor system 2427. The moving conveyor system 2427 transports the charged solid media to a collector tank 2430 for storage (line 12). The solid media ejector compressor can be a turbomachinery or a volumetric machine. In the former case, it can be a radial compressor, an axial compressor, or a mixed flow compressor, for example. In the latter case, it can be a reciprocating compressor, a vane compressor, a screw compressor, a Roots compressor, a liquid ring compressor, for example. The solid media ejector compressor 2424 can be in single or multi-stage configuration, with or without intercooling between compression stages.

The rotary airlock valves 2415, 2421 (or equivalent solid media injection and solid media ejection systems) minimize gas leaks towards the discharged and charged solid media conveyor systems, respectively, increasing system efficiency.

### Oxidation Reactor Description—High Pressure Configuration

FIG. 25 is a drawing depicting another example of a power generation system 2500 using an oxidation reactor 2503 according to one example of the present disclosure. Pressurized gas is flown through the oxidation reactor 2503 via a compressor 2506 (lines 1-2-6-8-7-10). The compressor 2506 can be a turbomachinery or a volumetric machine. In the former case, it can be a radial compressor, an axial compressor, or a mixed flow compressor, for example. In the latter case, it can be a reciprocating compressor, a vane compressor, a screw compressor, a Roots compressor, a liquid ring compressor, for example. The compressor unit can be in single or multi-stage configuration, with or without intercooling between compression stages.

The oxidation reactor 2503 can include a quenching zone (line 6), a recuperation zone (line 7), an oxidation furnace (line 8), and other suitable components. The charged solid media from a collector tank is fed to the top of the oxidation reactor 2503 through a moving conveyor system. A rotary airlock valve 2504 (or equivalent solid injection system) is used to feed the charged solid media into the top of the reactor (lines 3-4-5-7). The rotary airlock valve 2504 (or equivalent solid media injection system) injects the solid media into the pressurized reactor with minimal to no pressure losses despite the pressure difference between the charged solid media conveyor system (at ambient pressure, for example) and the oxidation reactor (pressurized at pressures between 1.5 and 150 bara, for example).

Electricity (or equivalent means, such as a solar concentrator, for example) is used to heat the central section of the oxidation reactor (line 8) to high temperatures (between 100° and 1500° C., for example) via, for example, an electricity to heat conversion device 2512 (line 21). This heating is only performed during system startup. While the solid state media is being chemically discharged, its exothermic oxidation reaction is capable of sustaining the temperature within the oxidation furnace (line 8) between 100° and 1500° C., for example, without the need of any external heat addition (from 21, for example). The higher the self-sustained furnace temperature, the lower the residence time needed by the solid state media particles to achieve their maximally discharged (oxidized) state.

When the gas and the charged solid media interact in the pre-heated oxidation furnace (line 8), they exchange heat and oxygen, promoting the chemical exothermic oxidation reaction of the solid media, which is accompanied by absorption of oxygen. The solid media exits the oxidation furnace (from line 8) at high temperatures. It is then quickly quenched in the quenching zone (line 6) by the incoming cold pressurized gas. The upward moving high temperature gas exiting the oxidation furnace (from line 8), instead, enters the recuperation zone (line 7) in which it gives off heat to the incoming charged solid media. As an outcome of this internal heat recuperation, both the gas and the solid media enter and exit the solid media oxidation reactor at close to ambient temperatures. This avoids the handling of high-temperature solids and gases as well as high-temperature sealing issues.

The gas exits the recuperation zone (line 7) through a pulsed valve 2515 (lines 16-17). This valve 2515 is pulsated on and off in order to avoid an over-pressure condition within the oxidation reactor 2503. The pulsed valve 2515 can be, for example, a butterfly valve, a ball valve, a segmented ball valve, a globe valve, a diaphragm valve, a globe valve, an angle valve, a gate valve, a needle valve, a plug valve, a pinch valve, among others. An equivalent device to the pulsed valve can be also installed, such as a pressure regulator, for example.

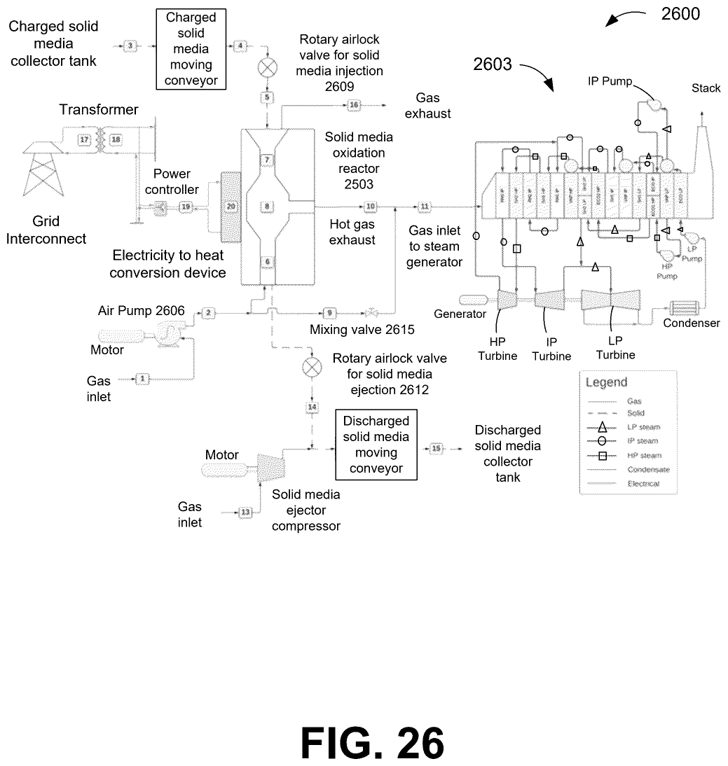

The heated pressurized gas exits the oxidation reactor (line 10) and is redirected towards an electricity generation system, such as an expander 2518 for electrical power generation (see lines 10-11 in FIG. 25), a steam generator 2603 as shown in FIG. 26, a heat engine, or other suitable electricity generation systems. The expander 2518 can be a turbomachinery or a volumetric machine. In the former case, it can be a radial expander, an axial expander, or a mixed flow expander, for example. In the latter case, it can be a piston expander, a vane expander, a screw compressor, a scroll expander, for example. The expander unit can be in single or multi-stage configuration. The relative amount of heated pressurized gas exiting the oxidation reactor (line 10) (versus the amount of gas exiting through the pulsed valve 2515) can be controlled by a combination of 1) using the pulsed valve to control the amount of backpressure, and 2) controlling the amount of charged flowing media entering the oxidation reactor 2503, for example.

If needed, a mixing valve 2521 (line 9) is installed to mix a fraction of the low-temperature compressed air (line 2) with the hot gas exhaust (line 10) in order to control the gas temperature at the expander inlet, between 40° and 1500° C., for example. The mixing valve 2521 can be, for example, a butterfly valve, a ball valve, a segmented ball valve, a globe valve, a diaphragm valve, a globe valve, an angle valve, a gate valve, a needle valve, a plug valve, a pinch valve, among others.

The now chemically discharged particles exit through the quenching zone (line 6) via a rotary airlock valve 2524 (or equivalent solid media ejection system). The rotary airlock valve 2524 (or equivalent solid media ejection system) ejects the solid media towards the discharged solid media moving conveyor system 2527 with minimal to no pressure losses despite the pressure difference between the discharged solid media conveyor system 2527 (at ambient pressure, for example) and the oxidation reactor 2503 (pressurized at pressures between 1.5 and 150 bara, for example).

To allow for storage of the discharged solid media, a solid media ejector compressor 2530 (from line 13) is activated at fixed time intervals to push the discharged solid media towards a moving conveyor system 2527. The moving conveyor system 2527 transports the discharged solid media to a collector tank for storage 2533 (line 15). The solid media ejector compressor 2530 can be a turbomachinery or a volumetric machine. In the former case, it can be a radial compressor, an axial compressor, or a mixed flow compressor, for example. In the latter case, it can be a reciprocating compressor, a vane compressor, a screw compressor, a Roots compressor, a liquid ring compressor, for example. The solid media ejector compressor unit can be in single or multi-stage configuration, with or without intercooling between compression stages.

The rotary airlock valves 2504, 2524 (or equivalent solid media injection and solid media ejection systems) minimize gas leaks towards the discharged and charged solid media conveyor systems, respectively, increasing system efficiency, and operate in such a way that the oxidation reactor is kept at the required operating pressure.

### Oxidation Reactor Description—Low Pressure Configuration

FIG. 26 is a drawing depicting another example of the power generation system 2600 using an oxidation reactor 2503 coupled with a steam generator 2603 according to one example of the present disclosure. Relative to the embodiment in FIG. 25, the main differences are the following:
The oxidation reactor 2503 operates at close to atmospheric pressures, hence the air pump 2606 is substituting the compressor (lines 1-2)
The rotary airlock valves 2609, 2612 (or equivalent solid media injection and solid media ejection systems) can be rated for a significant lower differential pressure rating (less than 3.5 bar, for example).
The gas exiting from the recirculation zone (line 7) can either reach the exhaust freely or a pulsed valve (or an equivalent device, such as a pressure regulator) similar to the one in FIG. 25 can be installed.
The hot exhaust gas (line 10) is mixed with the low-temperature air coming from the air pump 2606 (line 2) thanks to a mixing valve 2615 (line 9) in order to control the gas temperature at the inlet of the heat recovery steam generator 2603. Depending on the type of steam generator 2603, the inlet gas temperature can be controlled anywhere between 20° and 1500° C., for example.

In another variant of FIG. 26, the mixing valve 2615 on line 9 can be replaced by a second blower system (that processes ambient temperature air) that is connected to the outlet of the storage unit (between line 10 and 11).

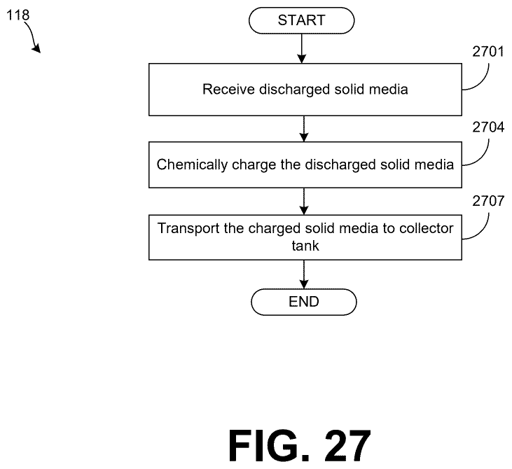

Referring next to FIG. 27, shown is a flowchart that provides one example of a charging mode of operation controlled by the controller 118 using a reduction reactor 2403 and solid-state thermochemical energy storage media (e.g., FIG. 24). The flowchart of FIG. 20A provides merely an example of the many different types of functional arrangements that can be employed to implement the operation of the depicted portion of the controller 118. As an alternative, the flowchart of FIG. 27 can be viewed as depicting an example of elements of a method implemented within the network environment 100. The method of operations for FIG. 27 can use at least the reduction reactor system 2403, other components of the power generation system 2400 from FIG. 24, and/or other suitable systems described in the present disclosure.

In block 2701, the controller 118 can cause the reduction reactor system 2403 or the power generation system 2400 to transport discharged solid media from a discharged solid media collector tank to the reduction reactor 2403. In some examples, discharged solid media from a collector tank 2409 is fed to the top of the reduction reactor 2403 through a moving conveyor system 2412. A rotary airlock valve 2415 (or equivalent solid media injection system) is used to feed the discharged solid media into the top of the reduction reactor 2403 (line 7). In some examples, the discharged solid media can represent discharged solid media in a pelletized form.

In block 2704, the controller 118 can cause the power generation system 2400 to chemically charge the discharged solid media. In some examples, the discharged solid media is received from the first rotary airlock valve 2415. The discharged solid media is converted to charged solid media at an elevated temperature. Electricity (or equivalent means, such as a solar concentrator, for example) is used to heat the central section of the reduction reactor 2403 (line 8) to high temperatures (between 100° and 1500° C., for example) via, for example, an electricity to heat conversion device 2418 (line 16). The higher the furnace temperature, the lower the residence time needed by the solid media to achieve their maximally charged (reduced) state. For example, the heat conversion device is configured to supply heat to the reduction reactor for converting the discharged solid media to the charged solid media.

When the gas and the discharged solid media interact in the reduction furnace (line 8), they exchange heat and oxygen, promoting the chemical endothermic reduction reaction of the solid media, which is accompanied by a release of oxygen. The solid fuel exits the reduction furnace (from line 8) at high temperatures. It is then quickly quenched in the quenching zone (line 6) by the incoming cold gas. The upward moving high temperature gas exiting the reduction furnace (from line 8), instead, enters the recuperation zone (line 7) in which it gives off heat to the incoming discharged solid media. As an outcome of this internal heat recuperation, both the gas and the solid media enter and exit the solid media oxidation reactor at close to ambient temperatures. This avoids the handling of high-temperature solids and gases as well as high-temperature sealing issues. Oxygen rich gas exits through line 9 at close to ambient temperatures. An air pump can supply the gas going through the reduction reactor (line 1-9).

In block 2707, the controller 118 can cause the reduction reactor system 2403 or the power generation system 2400 to transport the charged solid media to a charged media collector tank. In some examples, the charged solid media is received from the reduction reactor and provided to a rotary airlock valve at approximately ambient temperature. From the rotary airlock valve, the charged solid media can be transported to a moving conveyor system, and then to a charged media collector tank. Additional elements of the operations have been described previously with respect to FIG. 24. Then, the method can proceed to the end.

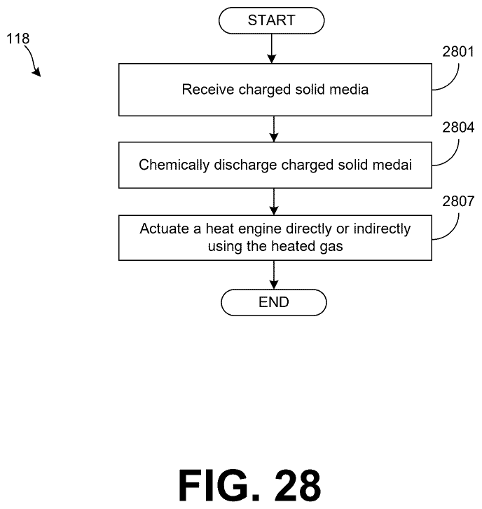

Referring next to FIG. 28, shown is a flowchart that provides one example of a discharging mode of operation controlled by the controller 118 using an oxidation reactor 2503 and solid-state thermochemical energy storage media (e.g., FIGS. 25 and 26). The flowchart of FIG. 28 provides merely an example of the many different types of functional arrangements that can be employed to implement the operation of the depicted portion of the controller 118. As an alternative, the flowchart of FIG. 28 can be viewed as depicting an example of elements of a method implemented within the network environment 100. The method of operations for FIG. 28 can use at least the power generation system 2500 from FIG. 25, the power generation system 2600 from FIG. 26, and other suitable systems described in the present disclosure.

In block 2801, the controller 118 can cause the power generation system 2500 to transport charged solid media from a charged media collector tank to the oxidation reactor 2503. In some examples, the power generation system 2500 transports the charged solid media from a charged solid media collector tank 2508 to a moving conveyor 2509. The charged media from the charged solid media collector tank 2508 is fed to the top of the oxidation reactor 2503 through a moving conveyor 2509. A rotary airlock valve 2504 (or equivalent solid media injection system) (also referred to as a first rotary airlock valve 2504) is used to feed the charged solid media into the top of the oxidation reactor 2503 (lines 3-4-5-7). The rotary airlock valve 2504 (or equivalent solid media injection system) injects the solid media into the pressurized reactor with minimal to no pressure losses despite the pressure difference between the charged solid media conveyor system 2509 (at ambient pressure, for example) and the oxidation reactor 2503 (pressurized at pressures between 1.5 and 150 bara, for example).

In block 2804, the controller 118 can cause the power generation system 2500 to use the oxidation reactor 2503 to chemically discharge the charged solid media in contact with oxygen-carrying gas and generate a heated gas from the chemical discharge of the charged solid media. Electricity (or equivalent means, such as a solar concentrator, for example) is used to heat the central section of the oxidation reactor (line 8) to high temperatures (between 100° and 1500° C., for example) via, for example, an electricity to heat conversion device 2512 (line 21). This heating is only performed during system startup. Once the solid media is being chemically discharged, its exothermic oxidation reaction is capable of sustaining the temperature within the oxidation furnace (line 8) between 100° and 1500° C., for example, without the need of any external heat addition (from 21, for example). The higher the self-sustained furnace temperature, the lower the residence time needed by the solid media particles to achieve their maximally discharged (oxidized) state.

In block 2807, the controller 118 can cause the power generation system 2500 to directly or indirectly actuate a heat engine using the heated gas from the oxidation reactor 2503. In some examples, the heated pressurized gas exits the oxidation reactor 2503 and is redirected towards an electricity generation system, such as an expander 2518 for electrical power generation (see lines 10-11 in FIG. 25), a steam generator 2603 as shown in FIG. 26, a heat engine, or other suitable electricity generation systems. Additional elements of the operations have been described previously with respect to FIGS. 25 and 26. Then, the method can proceed to the end.

The flowcharts of FIGS. 20A, 20B, 27, and 28 show the functionality and operation of an implementation of portions of the various embodiments of the present disclosure. The various blocks can be embodied in software or hardware. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. If embodied in hardware, each block can represent a circuit or a number of interconnected circuits to implement the specified logical function or functions.

Although the flowcharts of FIGS. 20A, 20B, 27, and 28 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 20A, 20B, 27, and 28 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Various embodiments of the present disclosure are described in the following clauses. Although the following clauses describe some embodiments of the present disclosure, other embodiments of the present disclosure are also set forth above.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

### Aspects

The present disclosure can be described in accordance with the following numbered Aspects, which should not be confused with the claims.

Aspect 1. A power generation system, comprising:
a thermal energy storage (TES) device or a thermochemical energy storage (TCES) device that is configured to increase a thermal energy storage capacity or a thermochemical energy storage capacity by passing an electrical current directly through the energy storage material; and
a controller that is configured to operate the power generation system in a charging mode, the controller being configured to:
   receive a charge signal;
   initiate a charging mode for the TES device or the TCES device based at least in part on the charge signal, the charging mode being initiated causes the electrical current to pass directly through the energy storage material; and
   terminate the charging mode based at least in part on a threshold temperature being reached or according to another signal from the controller.

Aspect 2. The power generation system of Aspect 1, wherein the charge signal represents an instruction for operating the charging mode while simultaneously operating a discharging mode for discharging the heated gas out of the TES device or the TCES device.

Aspect 3. The power generation system of claim 1, further comprising an oxygen extraction system that is configured to remove oxygen generated by a reduction reaction from an interior portion of the TCES device.

Aspect 4. The power generation system of Aspect 3, wherein the oxygen extraction system comprises:
an ejector system that is in fluid connection with an oxygen valve and receives oxygen extracted from an interior of the TCES device when the oxygen valve is opened; and
an atmospheric blower that provides a flow of ambient air to the ejector system, the flow of ambient air generates a suction force for extracting the oxygen from the interior of the TCES device.

Aspect 5. The power generation system of any one of Aspects 1-4, further comprising:
an oxygen extraction system that comprises:
   a blower valve that is situated in a fluid connection between the ejector system and the atmospheric blower; and
   an ambient valve is situated in a fluid connection between the ejector system and an ambient exit opening, the oxygen is extracted and released through the ambient exit opening.

Aspect 6. The power generation system of any one of Aspects 1-5, further comprising:
an oxygen extraction system that comprises:
a heat exchanger that is in fluid connection with the TCES device, the heat exchanger being configured to receive extracted oxygen from the TCES device when an oxygen valve is opened; and
an atmospheric blower that is in fluid connection with the heat exchanger and an ambient exit opening, the oxygen extracted from the TCES device being released through the ambient exit opening.

Aspect 7. The power generation system of any of Aspects 1-6, wherein the heat exchanger comprises a chiller and a centrifugal pump.

Aspect 8. A method of charging a thermochemical energy storage (TCES) device or a thermal energy storage (TES) device integrated with a power generation system comprising:
receiving, by a power generation system, a charge signal, the power generation system comprising a controller and a thermochemical energy storage (TCES) device or a thermal energy storage (TES) device, the TCES device or the TES device being configured to convert an electrical input into thermal energy or thermochemical energy;
initiating, by the controller, a charging mode for the TCES device or the TES device based at least in part on the charge signal, the charging mode being initiated causes the electrical input to pass directly through an energy storage material; and
terminating, by the controller, the charging mode based at least in part on a threshold temperature being reached or according to another signal from the controller.

Aspect 9. The method of Aspect 8, further comprising an oxygen extraction system that is configured to remove oxygen generated by a thermochemical reduction reaction from an interior portion of the TCES device.

Aspect 10. The method of Aspect 9, wherein the oxygen extraction system comprises:
a blower valve that is situated in a fluid connection between the ejector system and the atmospheric blower; and
an ambient valve is situated in a fluid connection between the ejector system and an ambient exit opening, the oxygen is extracted and released through the ambient exit opening.

Aspect 11. The method of claim 10, wherein the oxygen extraction system comprises:
a blower valve that is situated in a fluid connection between the ejector system and the atmospheric blower; and
an ambient valve is situated in a fluid connection between the ejector system and an ambient exit opening, the oxygen is extracted and released through the ambient exit opening.

Aspect 12 The method of any of Aspects 8-11, further comprising an oxygen extraction system that comprises:
a heat exchanger that is in fluid connection with the TCES device, the heat exchanger being configured to receive extracted oxygen from the TCES device when an oxygen valve is opened; and
an atmospheric blower that is in fluid connection with the heat exchanger and an ambient exit opening, the oxygen extracted from the TCES device being released through the ambient exit opening.

Aspect 13. A power generation system, comprising:
a thermochemical energy storage (TCES) device or a thermal energy storage (TES) device that is configured to increase the thermal energy storage capacity or the thermochemical energy storage capacity by passing an electrical current directly through an energy storage material, where the thermal energy storage capacity or the thermochemical energy storage capacity is used to generate a heated gas;
a heat engine that is directly or indirectly actuated by the heated gas discharging the TCES device or the TES device;
a controller that is configured to operate the TCES device or the TES device in a charging mode or a discharging mode based at least in part on a signal; and
the controller being configured to initiate the charging mode or the discharging mode based at least in part on identifying a power parameter from the signal, the charging mode instructing the TCES device or TES device to activate a transfer of heat from the energy storage material to the heated gas, the discharging mode instructing the TCES device or the TES device to discharge the heated gas.

Aspect 14. The power generation system of Aspect 13, where the heat engine powers an electric generator.

Aspect 15. The power generation system of Aspect 13 or 14, further comprising:
a heat exchanger that is in fluid connection with the TCES device or TES device, the heat exchanger being configured to receive heated gas from the TCES device or TES device; and
a damper system that supplies recirculated heated gas to the TCES device or TES device by supplying a controlled amount of an inlet ambient air or by supplying a controlled amount of the heated gas from the heat exchanger.

Aspect 16. The power generation system of Aspect 15, wherein the damper system comprises:
an inlet damper system for manipulating the controlled amount of the inlet ambident air; and
an outlet damper system for manipulating the controlled amount of the heated gas.

Aspect 17. The power generation system of any of Aspects 13-16, further comprising:
a recuperator that is configured to heat compressed air from a compressor using an exhaust gas line from a turbine.

Aspect 18. The power generation system of any of Aspects 13-16, further comprising:
a pressure control valve that controls an amount of compressed air provided from a compressor to the TCES device or the TES device.

Aspect 19. A power generation system for charging thermochemical energy in a solid state storage media, comprising:
a reduction reactor that receives discharged solid media in pelletized form;
the reduction reactor that is configured to chemically charge the discharged solid media, the discharged solid media being converted to charged solid media at an elevated temperature; and
a heat conversion device that is configured to supply heat to the reduction reactor for converting the discharged solid media to the charged solid media.

Aspect 20. A power generation system for discharging thermochemical energy in a solid state, comprising:
an solid media oxidation reactor that receives charged solid media;
the solid media oxidation reactor is configured to chemically discharge the charged solid media in contact with oxygen carrying gas and generate a heated gas from the chemical discharge of the charged solid media; and
a heat engine that is actuated directly or indirectly by the heated gas from the solid media oxidation reactor.

Aspect 21. The power generation system of Aspect 20, wherein the heat engine represents a first configuration that includes an expander and a generator or a second configuration that includes a steam generator.

Aspect 22. A power generation system comprising:
a thermochemical energy storage (TCES) device or a thermal energy storage (TES) device that is configured to increase the thermal energy storage capacity store energy or the thermochemical energy storage capacity by passing an electrical current directly through an energy storage material, wherein the thermal energy storage capacity or the thermochemical energy storage capacity is used to generate a heated gas;
a heat engine that is actuated directly or indirectly by the heated gas provided by the TCES device or the TES device; and
a controller that is configured to operate the power generation system in a discharging mode, the controller being configured to:
   receive a discharge signal;
   initiate the discharging mode for the TCES device based at least in part on the discharge signal, the discharging mode instructing the TCES device or the TES device to discharge the heated gas; and
   adjust an inlet temperature of the heated gas at the heat engine by actuating a mixing valve based at least in part on a requested power level associated with the discharge signal.

Aspects 23. The power generation system of Aspect 22, wherein the mixing valve that directs compressed air from a compressor to the heated gas from the TCES device or the TES device.

Aspects 24. The power generation system of Aspects 22 or 23, wherein the controller comprises at least one of an AC-DC controller multi-pulse rectifier, an AC-AC controller thyristor system, an on-load tap changer (OLTC) that, via either a mechanical switch or a semiconductor switch, automatically selects an appropriate secondary winding of a power transformer depending on a voltage requirement of the TCES device or the TES device.

Therefore, the following is claimed:

1. A power generation system, comprising:
a thermal energy storage (TES) device or a thermochemical energy storage (TCES) device that is configured to increase a thermal energy storage capacity or a thermochemical energy storage capacity by passing an electrical current directly through the energy storage material; and
a controller that is configured to operate the power generation system in a charging mode, the controller being configured to:
receive a charge signal;
initiate a charging mode for the TES device or the TCES device based at least in part on the charge signal, the charging mode being initiated causes the electrical current to pass directly through the energy storage material; and
terminate the charging mode based at least in part on a threshold temperature being reached or according to another signal from the controller.

2. The power generation system of claim 1, wherein the charge signal represents an instruction for operating the charging mode while simultaneously operating a discharging mode for discharging the heated gas out of the TES device or the TCES device.

3. The power generation system of claim 1, further comprising an oxygen extraction system that is configured to remove oxygen generated by a reduction reaction from an interior portion of the TCES device.

4. The power generation system of claim 3, wherein the oxygen extraction system comprises:
an ejector system that is in fluid connection with an oxygen valve and receives oxygen extracted from an interior of the TCES device when the oxygen valve is opened; and
an atmospheric blower that provides a flow of ambient air to the ejector system, the flow of ambient air generates a suction force for extracting the oxygen from the interior of the TCES device.

5. The power generation system of claim 1, further comprising:
an oxygen extraction system that comprises:
a blower valve that is situated in a fluid connection between the ejector system and the atmospheric blower; and
an ambient valve is situated in a fluid connection between the ejector system and an ambient exit opening, the oxygen is extracted and released through the ambient exit opening.

6. The power generation system of claim 1, further comprising:
an oxygen extraction system that comprises:
a heat exchanger that is in fluid connection with the TCES device, the heat exchanger being configured to receive extracted oxygen from the TCES device when an oxygen valve is opened; and
an atmospheric blower that is in fluid connection with the heat exchanger and an ambient exit opening, the oxygen extracted from the TCES device being released through the ambient exit opening.

7. A method of charging a thermochemical energy storage (TCES) device or a thermal energy storage (TES) device integrated with a power generation system comprising:
receiving, by a power generation system, a charge signal, the power generation system comprising a controller and a thermochemical energy storage (TCES) device or a thermal energy storage (TES) device, the TCES device or the TES device being configured to convert an electrical input into thermal energy or thermochemical energy;
initiating, by the controller, a charging mode for the TCES device or the TES device based at least in part on the charge signal, the charging mode being initiated causes the electrical input to pass directly through an energy storage material; and
terminating, by the controller, the charging mode based at least in part on a threshold temperature being reached or according to another signal from the controller.

8. The method of claim 7, further comprising an oxygen extraction system that is configured to remove oxygen generated by a thermochemical reduction reaction from an interior portion of the TCES device.

9. The method of claim 8, wherein the oxygen extraction system comprises:
an ejector system that is in fluid connection with an oxygen valve and receives oxygen extracted from an interior of the TCES device when the oxygen valve is opened; and
an atmospheric blower that provides a flow of ambient air to the ejector system, the flow of ambient air generates a suction force for extracting the oxygen from the interior of the TCES device.

10. The method of claim 9, wherein the oxygen extraction system comprises:
a blower valve that is situated in a fluid connection between the ejector system and the atmospheric blower; and
an ambient valve is situated in a fluid connection between the ejector system and an ambient exit opening, the oxygen is extracted and released through the ambient exit opening.

11. The method of claim 7, further comprising an oxygen extraction system that comprises:
a heat exchanger that is in fluid connection with the TCES device, the heat exchanger being configured to receive extracted oxygen from the TCES device when an oxygen valve is opened; and
an atmospheric blower that is in fluid connection with the heat exchanger and an ambient exit opening, the oxygen extracted from the TCES device being released through the ambient exit opening.

12. A power generation system, comprising:
a thermochemical energy storage (TCES) device or a thermal energy storage (TES) device that is configured to increase the thermal energy storage capacity or the thermochemical energy storage capacity by passing an electrical current directly through an energy storage material, wherein the thermal energy storage capacity or the thermochemical energy storage capacity is used to generate a heated gas;
a heat engine that is directly or indirectly actuated by the heated gas discharging the TCES device or the TES device;
a controller that is configured to operate the TCES device or the TES device in a charging mode or a discharging mode based at least in part on a signal; and
the controller being configured to initiate the charging mode or the discharging mode based at least in part on identifying a power parameter from the signal, the charging mode instructing the TCES device or TES device to activate a transfer of heat from the energy storage material to the heated gas, the discharging mode instructing the TCES device or the TES device to discharge the heated gas.

13. The power generation system of claim 12, wherein the heat engine powers an electric generator.

14. The power generation system of claim 12, further comprising:
a heat exchanger that is in fluid connection with the TCES device or TES device, the heat exchanger being configured to receive heated gas from the TCES device or TES device; and
a damper system that supplies recirculated heated gas to the TCES device or TES device by supplying a controlled amount of the heated gas from the heat exchanger.

15. The power generation system of claim 14, wherein the damper system comprises:
an inlet damper system for manipulating the controlled amount of the inlet ambient air; and
an outlet damper system for manipulating the controlled amount of the heated gas.

16. The power generation system of claim 12, further comprising:
a recuperator that is configured to heat compressed air from a compressor using an exhaust gas line from a turbine.

17. The power generation system of claim 12, further comprising:
a pressure control valve that controls an amount of compressed air provided from a compressor to the TCES device or the TES device.

18. A power generation system for charging thermochemical energy in a solid state energy storage media, comprising:
a reduction reactor that receives discharged solid media;
the reduction reactor that is configured to chemically charge the discharged solid media, the discharged solid media being converted to charged solid media at an elevated temperature; and
a heat conversion device that is configured to supply heat to the reduction reactor for converting the discharged solid media to the charged solid media.

19. A power generation system for discharging thermochemical energy from a solid energy storage media, comprising:
a solid media oxidation reactor that receives charged solid media;
the solid media oxidation reactor is configured to chemically discharge the charged solid media in contact with oxygen carrying gas and generate a heated gas from the chemical discharge of the charged solid media; and
a heat engine that is actuated directly or indirectly by the heated gas from the solid media oxidation reactor.
